(19) United States
(12) Patent Application Publication
(10) Pub. No.: US 2026/0211351 A1
(43) Pub. Date: Jul. 23, 2026

(54) TONER FOR DEVELOPMENT OF ELECTROSTATIC IMAGES

(71) Applicant: KAO CORPORATION, Tokyo (JP)

(72) Inventors: Kanta NIIYA, Wakayama-shi (JP); Yuji MARUNO, Wakayama-shi (JP); Manabu SUZUKI, Wakayama-shi (JP); Shoichi MURATA, Wakayama-shi (JP)

(73) Assignee: KAO CORPORATION, Tokyo (JP)

(21) Appl. No.: 19/137,322

(22) PCT Filed: Dec. 19, 2023
(86) PCT No.: PCT/JP2023/045489

§ 371 Date: Jun. 10, 2025

(30) Foreign Application Priority Data
Dec. 19, 2022 (JP) 2022-202385

(51) Int. Cl. G03G 9/09; G03G 9/08; G03G 9/087

(52) U.S. Cl. CPC G03G 9/0904; G03G 9/0804; G03G 9/08755

(57) ABSTRACT

A toner for electrostatic image development. The toner contains a binder resin and a colorant. The binder resin contains an amorphous polyester resin A having an ester group concentration of 5.0 mmol/g or more and 15.0 mmol/g or less, and the colorant contains carbon black having a BET specific surface area of 200 m²/g or more.

### TECHNICAL FIELD

The present invention relates to a toner for electrostatic image development used for developing a latent image formed in an electrophotographic method, an electrostatic recording method, an electrostatic printing method, or the like.

### BACKGROUND ART

In the field of electrophotography, development of electrophotographic toners corresponding to high image quality and high speed is required with development of the electrophotographic system. In a black toner, carbon black is widely used as a colorant, and studies have been conducted on the improvement of the image density of a printed matter.

Patent Literature 1 (JP 2020-154020 A) discloses, for the purpose of providing a method for producing a toner for electrostatic image development having high coloring power and excellent environmental stability, a method for producing a toner for electrostatic image development including a step of mixing at least a binder resin, a colorant, and an organic solvent to prepare an oil phase, and a step of mixing the oil phase and an aqueous phase, wherein the colorant is carbon black having a DBP oil absorption of 25 mL/100 g or more and 45 mL/100 g or less and a BET specific surface area of 65 m²/g or more and 120 m²/g or less, the binder resin contains an amorphous resin, and the amorphous resin contains at least one of an amorphous polyester resin having an aliphatic hydrocarbon group having 8 or more carbons on a side chain and an amorphous composite resin containing a polyester segment and an addition polymerization resin segment.

Patent Literature 2 (JP 2014-222344 A) discloses, for the purpose of providing a chemical toner composition, a toner composition containing a resin and a colorant, wherein the colorant is a) a modified pigment containing a pigment to which a specific organic group is bonded, or b) a modified pigment containing a pigment in which at least one phenyl-containing polymer is adsorbed on a surface of the colorant.

### SUMMARY OF INVENTION

The present invention relates to [1] described below.

[1] A toner for electrostatic image development, containing a binder resin and a colorant, wherein
the binder resin contains an amorphous polyester resin A having an ester group concentration of 5.0 mmol/g or more and 15.0 mmol/g or less, and
the colorant contains carbon black having a BET specific surface area of 200 m²/g or more.

### DESCRIPTION OF EMBODIMENTS

To increase the image density of a printed matter, it is essential to homogeneously disperse the colorant in toner particles. However, since carbon black has a strong particle cohesive force, it is not easy to disperse the colorant in the toner particles. Even when printing is performed with the toners described in Patent Literatures 1 and 2, the image density of a printed matter is not yet sufficient.

The present invention relates to a toner for electrostatic image development capable of achieving a printed matter having a high image density.

The present inventors have found that a printed matter having a high image density can be obtained by using a toner for electrostatic image development containing, in combination, a binder resin containing an amorphous polyester resin having an ester group concentration in a specific range and a colorant containing carbon black having a relatively large BET specific surface area.

The present invention can provide a toner for electrostatic image development capable of achieving a printed matter having a high image density.

### [Toner for Electrostatic Image Development]

The toner for electrostatic charge image development (hereinafter, also simply referred to as “toner”) of the present invention contains at least a binder resin and a colorant.

The binder resin contains an amorphous polyester resin A (hereinafter, also simply referred to as “resin A”) having an ester group concentration of 5.0 mmol/g or more and 15.0 mmol/g or less. The colorant contains carbon black having a BET specific surface area of 200 m²/g or more.

Because of the above characteristics, a printed matter having a high image density can be obtained using the toner of the present invention. Examples of the recording medium for the toner of the present invention include paper and a film.

Toner particles containing at least a binder resin and a colorant (hereinafter, also simply to as “toner particles”) can be used as they are as the toner of the present invention, but it is preferable to use, as the toner, toner particles to which a fluidizer or the like is added as an external additive on the surface of the toner particles.

The reason why a printed matter having a high image density can be obtained by using the toner of the present invention is not clear, but the reason is considered as follows.

Since carbon black having a high BET specific surface area contains small primary particles, the carbon black has a high coloring power, which makes it possible to obtain a printed matter having a potentially high image density. However, when the BET specific surface area is high, the number of functional groups (e.g., carboxy groups and hydroxy groups) present on the particle surfaces per mass unit also increases. Thus, carbon black having a high BET specific surface area is unlikely to disperse in a binder resin and is easily aggregated therein. In the case of producing a toner through kneading by a pulverization method or through a coalescing step by a chemical method using a binder resin, when the raw material mixture is heated at a temperature equal to or higher than the glass transition temperature of the amorphous resin and held in a low viscosity state, carbon black having a high BET specific surface area is aggregated because of the action of hydrogen bonding or the like. In this case, sufficient image density cannot be achieved in a printed matter using a toner containing carbon black having a high BET specific surface area.

In the present invention, by using the amorphous polyester resin A having a relatively high ester group concentration, the functional group on the surface of carbon black and the ester moiety of the amorphous polyester resin A interact with each other through hydrogen bonding or the like. Thus, even when the raw material mixture is held in a low viscosity state, aggregation of carbon black having a high BET specific surface area (small primary particle size) is suppressed in the raw material mixture, and a toner in which carbon black is homogeneously dispersed in toner particles can be produced. It is considered that, as a result, the image density of a printed matter produced using the toner can be improved.

Definitions and the like of various terms in the present specification are described below.

In the specification, a carboxylic acid component of a polyester-based resin includes not only its compound, but also an anhydride that is decomposed during the reaction to generate a carboxylic acid and an alkyl ester of each carboxylic acid (having 1 or more and 3 or less carbons in the alkyl group).

Whether a resin is crystalline or amorphous is determined by using the crystallinity index. The crystallinity index is defined by the ratio of the softening point of the resin to the maximum endothermic peak temperature thereof (softening point (° C.)/maximum endothermic peak temperature (° C.)) in the measurement method described below in Examples. A crystalline resin is a resin having a crystallinity index of 0.6 or more and 1.4 or less. An amorphous resin is a resin exhibiting no endothermic peak or having a crystallinity index of less than 0.6 or more than 1.4 when an endothermic peak is observed. The crystallinity index can be appropriately adjusted by the types of raw material monomers and the proportions thereof, and production conditions such as reaction temperature, reaction time, and cooling rate.

“(Meth)acrylic acid” means at least one selected from acrylic acid and methacrylic acid.

“(Meth)acrylate” means at least one selected from acrylate and methacrylate.

“Styrene-based compound” means unsubstituted or substituted styrene.

### [Toner Particles]

In the present invention, the toner particles contain at least a binder resin and a colorant.

### <Binder Resin>

The binder resin contains an amorphous polyester resin A (hereinafter, also simply referred to as “resin A”) having an ester group concentration of 5.0 mmol/g or more and 15.0 mmol/g or less.

### (Amorphous Polyester Resin A)

The amorphous polyester resin A is a polycondensate of an alcohol component (a) and a carboxylic acid component (b).

The alcohol component (a) preferably contains an aliphatic diol, and more preferably contains a linear or branched aliphatic diol having 2 or more and 6 or less carbons.

Examples of the linear or branched aliphatic diol having 2 or more and 6 or less carbons include ethylene glycol, 1,2-propanediol, 1,3-propanediol, 1,2-butanediol, 1,3-butanediol, 1,4-butanediol, 2,3-butanediol, 2-methyl-1,3-propanediol, 1,2-pentanediol, 1,3-pentanediol, 1,4-pentanediol, 2,3-pentanediol, 2,4-pentanediol, neopentyl glycol, 2-ethyl-2-methyl-1,3-propanediol, 2-methyl-1,4-butanediol, 2-ethyl-1,4-butanediol, 2,2-dimethyl-1,4-butanediol, 2,3-dimethyl-1,4-butanediol, 2-methyl-1,5-pentanediol, and 3-methyl-1,5-pentanediol. Among these, 1,2-propanediol, neopentyl glycol, 2-ethyl-2-methyl-1,3-propanediol, 2,2-dimethyl-1,4-butanediol, and 3-methyl-1,5-pentanediol are preferable, 1,2-propanediol, neopentyl glycol, and 3-methyl-1,5-pentanediol are more preferable, and 1,2-propanediol and neopentyl glycol are still more preferable.

One type or two or more types of these aliphatic diols may be used.

The content of the aliphatic diol in the alcohol component (a) is preferably 80 mol % or more, more preferably 85 mol % or more, still more preferably 90 mol % or more, and is preferably 100 mol % or less, more preferably 100 mol %, from the viewpoint of achieving a desired ester group concentration.

Examples of the alcohol component (a) other than the aliphatic diol include an aromatic diol alkylene oxide adduct and a trivalent or higher-valent polyhydric alcohol.

Examples of the aromatic diol alkylene oxide adduct include a bisphenol A alkylene oxide adduct represented by Formula (I):

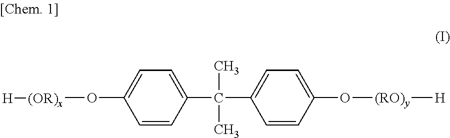

(wherein OR and RO are an oxyalkylene group, R is each independently an ethylene or propylene group, x and y represent the number of moles added of the alkylene oxide and are each a positive number, and the sum of x and y is 1 or more, preferably 1.5 or more, and 16 or less, preferably 8 or less, more preferably 4 or less).

Examples of the bisphenol A alkylene oxide adduct represented by Formula (I) include a 2,2-bis(4-hydroxyphenyl)propane propylene oxide adduct and a 2,2-bis(4-hydroxyphenyl)propane ethylene oxide adduct.

Examples of the trivalent or higher-valent polyhydric alcohol include glycerin, pentaerythritol, trimethylolpropane, and sorbitol.

One type or two or more types of these may be used.

Examples of the carboxylic acid component (b) include aromatic dicarboxylic acids, aliphatic dicarboxylic acids, alicyclic dicarboxylic acids, and trivalent or higher-valent carboxylic acids.

Among these, the carboxylic acid component (b) preferably contains an aromatic dicarboxylic acid from the viewpoint of achieving a desired ester group concentration.

From the above viewpoint, the aromatic dicarboxylic acid is more preferably at least one selected from terephthalic acid and isophthalic acid, and still more preferably contains terephthalic acid and isophthalic acid.

The content of the aromatic dicarboxylic acid in the carboxylic acid component (b) is preferably 60 mol % or more, more preferably 70 mol % or more, still more preferably 80 mol % or more, and 100 mol % or less, from the viewpoint of obtaining the amorphous polyester resin A having a desired ester group concentration.

Examples of the aliphatic dicarboxylic acid include aliphatic dicarboxylic acids such as oxalic acid, malonic acid, maleic acid, fumaric acid, citraconic acid, itaconic acid, glutaconic acid, adipic acid, succinic acid, and succinic acid optionally substituted with an aliphatic hydrocarbon group having 1 or more and 20 or less carbons.

Examples of the succinic acid substituted with an aliphatic hydrocarbon group having 1 or more and 20 or less carbons include octylsuccinic acid and dodecenylsuccinic acid (tetrapropenylsuccinic acid).

Examples of the alicyclic dicarboxylic acid include cyclohexanedicarboxylic acid.

The content of the aliphatic dicarboxylic acid in the carboxylic acid component (b) is preferably 40 mol % or less, more preferably 20 mol % or less, and 0 mol % or more, from the viewpoint of obtaining the amorphous polyester resin A having a desired ester group concentration.

Examples of the trivalent or higher-valent carboxylic acid include 1,2,4-benzenetricarboxylic acid (trimellitic acid), 2,5,7-naphthalenetricarboxylic acid, and pyromellitic acid. Among these, trimellitic acid and an anhydride thereof are preferable.

The content of the trivalent or higher-valent carboxylic acid in the carboxylic acid component (b) is preferably 20 mol % or less, more preferably 15 mol % or less, still more preferably 10 mol % or less, and 0 mol % or more, from the viewpoint of obtaining the amorphous polyester resin A having a desired ester group concentration.

The alcohol component (a) may appropriately contain a monohydric alcohol, and the carboxylic acid component (b) may appropriately contain a monovalent carboxylic acid compound.

The equivalent ratio of carboxy groups of the carboxylic acid component to hydroxyl groups of the alcohol component (a) [COOH group/OH group] is preferably 0.7 or more and more preferably 0.8 or more, and is preferably 1.3 or less and more preferably 1.2 or less.

The resin A has an ester group concentration of 5.0 mmol/g or more and 15.0 mmol/g or less, preferably 5.5 mmol/g or more, more preferably 6.0 mmol/g or more, and preferably 13.0 mmol/g or less, more preferably 12.0 mmol/g or less, from the viewpoint of the image density of the printed matter. The ester group concentration of the resin A is calculated from the following formula.

$$[ Math . 1 ]$$

$$[ Ester group concentration ( mmol / g ) ] = \frac{[ A ( mol ) ]}{[ B ( g ) - A ( mol ) \times 18 ]} \times {10}^{3}$$

[In the formula, A is the total ester bond amount (mol) produced when all the raw material monomers of the amorphous polyester resin A are reacted, and B is the total mass (g) of the raw material monomers constituting the amorphous polyester resin A. In the formula, the unit of each numerical value is shown in parentheses.]

When two or more resins are mixed and used as the amorphous polyester resin A, the weighted average of the ester group concentrations of the respective amorphous polyester resins A is taken as the ester group concentration of the amorphous polyester resin A.

When a crystalline polyester resin C described below is used in addition to the amorphous polyester resin A, the weighted average of the ester group concentrations of the respective resins is preferably 5.0 mmol/g or more, more preferably 5.5 mmol/g or more, and still more preferably 6.0 mmol/g or more, and is preferably 15.0 mmol/g or less, more preferably 13.0 mmol/g or less, and still more preferably 12.0 mmol/g or less.

### «Method for Producing Amorphous Polyester Resin A»

The resin A can be produced, for example, through polycondensation of the raw material monomers containing the alcohol component (a) and the carboxylic acid component (b).

The polycondensation of the alcohol component (a) and the carboxylic acid component (b) can be performed, for example, at a temperature of about 120° C. or higher and 250° C. or lower in an inert gas atmosphere in the presence of an esterification catalyst, an esterification promoter, a polymerization inhibitor, or the like as necessary.

Examples of the esterification catalyst include tin compounds such as dibutyltin oxide and tin(II) di(2-ethylhexanoate), and titanium compounds such as titanium diisopropoxybis(triethanolaminate). Examples of the esterification promoter that can be used together with the esterification catalyst include gallic acid.

The amount of the esterification catalyst to be used is preferably 0.01 parts by mass or more and 10 parts by mass or less relative to 100 parts by mass of the total amount of the alcohol component (a) and the carboxylic acid component (b), which are raw material monomers of the resin A.

The amount of the esterification promoter to be used is preferably 0.001 parts by mass or more and 1 part by mass or less relative to 100 parts by mass of the total amount of the alcohol component (a) and the carboxylic acid component (b).

Examples of the polymerization inhibitor include radical polymerization inhibitors such as 4-tert-butylcatechol.

When a polymerization inhibitor is used, the amount of the polymerization inhibitor to be used is preferably 0.001 parts by mass or more and 1 part by mass or less relative to 100 parts by mass of the total amount of the alcohol component (a) and the carboxylic acid component (b).

### «Physical Properties of Amorphous Polyester Resin A»

The softening point of the resin A is preferably 70° C. or higher, more preferably 80° C. or higher, and still more preferably 90° C. or higher from the viewpoint of heat-resistant storage stability, and is preferably 130° C. or lower, and more preferably 120° C. or lower from the viewpoint of low-temperature fusing property.

The glass transition temperature of the resin A is preferably 30° C. or higher, more preferably 35° C. or higher, and still more preferably 40° C. or higher from the viewpoint of heat-resistant storage stability, and is preferably 80° C. or lower, and more preferably 75° C. or lower from the viewpoint of low-temperature fusing property.

The acid value of the resin A is preferably 5 mgKOH/g or more, more preferably 8 mgKOH/g or more, and still more preferably 10 mgKOH/g or more, and is preferably 40 mgKOH/g or less, more preferably 30 mgKOH/g or less, and still more preferably 25 mgKOH/g or less.

The ester group concentration, softening point, glass transition temperature, and acid value of the resin A can be appropriately adjusted depending on the types and the amounts of the raw material monomers to be used, and the production conditions such as the reaction temperature, the reaction time, and the cooling rate. The softening point, glass transition temperature, and acid value of the resin A are determined by the methods described in Examples.

When two or more types of resins A are used in combination, it is preferable that the softening point, glass transition temperature, and acid value of the mixture of the resins respectively fall within the above ranges.

### (Amorphous Resin B)

The binder resin may contain an amorphous resin B (hereinafter, also simply referred to as “resin B”) besides the resin A. Examples of the resin B include amorphous polyester resins having an ester group concentration of less than 5.0 mmol/g and styrene acrylic resins.

### (Crystalline Polyester Resin C)

From the viewpoint of the image density with the toner, the binder resin may contain a crystalline polyester resin C (hereinafter, also simply referred to as “resin C”), and preferably contains the resin C.

The crystalline polyester resin C is a polycondensate of an alcohol component and a carboxylic acid component.

The alcohol component is preferably an α,ω-aliphatic diol.

The carbon number of the α,ω-aliphatic diol is preferably 2 or more, and is preferably 16 or less, more preferably 14 or less, and still more preferably 12 or less.

Examples of the α,ω-aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, and 1,14-tetradecanediol. Among these, ethylene glycol, 1,6-hexanediol, 1,10-decanediol, and 1,12-dodecanediol are preferable, ethylene glycol and 1,10-decanediol are more preferable, and ethylene glycol is still more preferable.

The amount of the α,ω-aliphatic diol in the alcohol component is preferably 80 mol % or more, more preferably 85 mol % or more, still more preferably 90 mol % or more, still more preferably 95 mol % or more, and 100 mol % or less, preferably 100 mol %.

The alcohol component may contain an additional alcohol component different from the α,ω-aliphatic diol. Examples of the additional alcohol component include aliphatic diols other than the α,ω-aliphatic diol, such as 1,2-propanediol and neopentyl glycol; aromatic diol alkylene oxide adducts such as bisphenol A alkylene oxide adducts; and trivalent or higher-valent alcohols such as glycerin, pentaerythritol, and trimethylolpropane. One type or two or more types of these alcohol components may be used.

The carboxylic acid component is preferably an aliphatic dicarboxylic acid, and is more preferably a linear aliphatic dicarboxylic acid.

The number of carbons in the aliphatic dicarboxylic acid is preferably 4 or more, more preferably 8 or more, still more preferably 10 or more, and is preferably 14 or less, more preferably 12 or less.

Examples of the aliphatic dicarboxylic acid include fumaric acid, sebacic acid, dodecanedioic acid, and tetradecanedioic acid. Among these, sebacic acid and dodecanedioic acid are preferable, and dodecanedioic acid is more preferable. One type or two or more types of these carboxylic acid components may be used.

The amount of the aliphatic dicarboxylic acid in the carboxylic acid component is preferably 80 mol % or more, more preferably 85 mol % or more, still more preferably 90 mol % or more, still more preferably 95 mol % or more, and 100 mol % or less, preferably 100 mol %.

The carboxylic acid component may contain an additional carboxylic acid component different from the aliphatic dicarboxylic acid. Examples of the additional carboxylic acid component include monocarboxylic acids such as stearic acid and behenic acid; aromatic dicarboxylic acids such as terephthalic acid and isophthalic acid; and trivalent or higher polyvalent carboxylic acids. One type or two or more types of these carboxylic acid components may be used.

The equivalent ratio of the carboxy groups of the carboxylic acid component to the hydroxyl groups of the alcohol component [COOH group/OH group] is preferably 0.7 or more and more preferably 0.8 or more, and is preferably 1.3 or less and more preferably 1.2 or less.

Examples of the method for producing the resin C include the same method as the method for producing the amorphous polyester resin A.

### «Physical Properties of Crystalline Polyester Resin C»

The ester group concentration of the resin C is preferably 5.0 mmol/g or more, more preferably 6.0 mmol/g or more, and still more preferably 7.0 mmol/g or more, and is preferably 12.0 mmol/g or less, more preferably 11.0 mmol/g or less, and still more preferably 10.0 mmol/g or less, from the viewpoint of production of the crystalline polyester resin.

The ester group concentration of the resin C is calculated in the same manner as the ester group concentration of the resin C. That is, the ester group concentration of the resin C is calculated by replacing “total ester bond amount (mol) produced when all the raw material monomers of the amorphous polyester resin A are reacted” with “total ester bond amount (mol) produced when all the raw material monomers of the crystalline polyester resin C are reacted” in “A” and replacing “total mass (g) of the raw material monomers constituting the amorphous polyester resin A” with “total mass (g) of the raw material monomers constituting the crystalline polyester resin C” in “B” in the formula for calculating the ester group concentration of the resin A.

The softening point of the resin C is preferably 60° C. or higher, more preferably 70° C. or higher, and still more preferably 80° C. or higher, and, from the viewpoint of further improving the low-temperature fusing property, the softening point of the resin C is preferably 150° C. or lower, more preferably 120° C. or lower, and still more preferably 100° C. or lower.

The melting point of the resin C is preferably 50° C. or higher, more preferably 60° C. or higher, still more preferably 70° C. or higher, and still more preferably 80° C. or higher, and, from the viewpoint of further improving the low-temperature fusing property, the melting point of the resin C is preferably 100° C. or lower, more preferably 90° C. or lower, and still more preferably 85° C. or lower.

The acid value of the resin C is preferably 5 mgKOH/g or more, more preferably 10 mgKOH/g or more, and is preferably 35 mgKOH/g or less, more preferably 25 mgKOH/g or less, still more preferably 20 mgKOH/g or less.

The softening point, melting point, and acid value of the resin C can be appropriately adjusted depending on the types and amounts of the raw material monomers to be used, and the production conditions such as the reaction temperature, the reaction time, and the cooling rate. The softening point, melting point, and acid value of the resin C are determined by the methods described below in Examples. When two or more resins C are used in combination, it is preferable that the softening point, melting point, and acid value of the mixture of the resins respectively fall within the above ranges.

In the present invention, the binder resin means the resin A, the resin B, and the resin C.

The content of the binder resin in the toner particles is preferably 60 mass % or more, more preferably 65 mass % or more, still more preferably 70 mass % or more, and is preferably less than 100 mass %, more preferably 95 mass % or less, from the viewpoint of the image density of the printed matter.

The content of the resin A in the binder resin is preferably 70 mass % or more, more preferably 80 mass % or more, still more preferably 90 mass % or more, and 100 mass % or less, from the viewpoint of the image density of the printed matter.

When the binder resin contains the resin C, the content of the resin C in the binder resin is preferably 5 mass % or more, more preferably 10 mass % or more, still more preferably 15 mass % or more, and is preferably 40 mass % or less, more preferably 30 mass % or less, still more preferably 25 mass % or less, from the viewpoint of the image density of the printed matter.

When the binder resin contains the resin C, the mass ratio of the resin C to the resin A [resin C/resin A] in the resin particles is preferably 5/95 or more, more preferably 10/90 or more, still more preferably 15/85 or more, and is preferably 40/60 or less, more preferably 30/70 or less, still more preferably 25/75 or less, from the viewpoint of the thermal responsiveness of the toner.

### <Colorant>

In the present invention, the colorant contains carbon black having a BET specific surface area of 200 m²/g or more (hereinafter, may be simply referred to as “carbon black” or “pigment”).

Examples of the carbon black include furnace black, thermal lamp black, acetylene black, and channel black. Among these, furnace black is preferable from the viewpoint of coloring power.

The pH value of the carbon black is preferably 5.0 or more, more preferably 6.0 or more, still more preferably 7.0 or more, and is preferably 10.0 or less, more preferably 9.0 or less, still more preferably 8.5 or less, from the viewpoint of further improving the image density of the toner.

Specifically, the pH value of carbon black can be measured by the following procedure.
(1) 6 g of carbon black, 79 mL of distilled water having a pH of 7, and 1 g of ethanol are collected in a container and mixed.
(2) The mixture is boiled for 15 minutes and then cooled to normal temperature in 30 minutes.
(3) The supernatant is removed by decantation to prepare a slurry having a solid content of 30 to 35 mass %.
(4) A pH electrode is inserted into the slurry, and the pH is measured.

The pH value of the slurry is defined as the pH value of the carbon black.

Examples of the pH meter include “Seven 2Go S2” (available from METTLER TOLEDO).

The dibutyl phthalate (DBP) oil absorption of the carbon black is preferably 30 ml/100 g or more, more preferably 60 ml/100 g or more, still more preferably 100 ml/100 g or more, and is preferably 160 ml/100 g or less, more preferably 140 ml/100 g or less, still more preferably 125 ml/100 g or less, from the viewpoint of the chargeability of the toner.

The DBP oil absorption of the carbon black is measured in accordance with “Method for Determining Oil Absorption Amount” of ISO4656 (JIS K 6217-4:2008).

The BET specific surface area of the carbon black is preferably 205 m²/g or more, and more preferably 210 m²/g or more, and is preferably 290 m²/g or less, more preferably 275 m²/g or less, still more preferably 260 m²/g or less, and still more preferably 250 m²/g or less, from the viewpoint of being able to obtain a printed matter having a higher image density and obtaining a toner for electrostatic image development having excellent environmental stability.

The BET specific surface area of the carbon black can be measured by the method described in Examples in accordance with JIS K 6217-2:2017.

Some carbon blacks are approved as food contact substances by the Food and Drug Administration (FDA). When the toner of the present invention is applied to a printed matter that may come into contact with a food, such as a wrapping sheet, it is preferable to use such carbon blacks. That is, in accordance with FDA approval standards, the amount of the polycyclic aromatic hydrocarbon (PAH) contained in the carbon black is preferably 10 ppb or less on a mass basis.

Examples of commercially available carbon blacks include “Printex F80” (available from Orion Engineered Carbons S.A., pH 8.1, DBP oil absorption: 105 ml/100 g, BET specific surface area: 225 m²/g), “Black Pearls 4750” (available from Cabot Corporation, pH 7.9, DBP oil absorption: 117 ml/100 g, BET specific surface area: 240 m²/g), “Monarch 4750” (available from Cabot Corporation, pH 7.9, DBP oil absorption: 122 ml/100 g, BET specific surface area: 258 m²/g), and “Monarch 880” (available from Cabot Corporation, pH 7.4, DBP oil absorption: 105 ml/100 g, BET specific surface area: 258 m²/g).

One type or two or more types of carbon blacks may be used.

The content of the carbon black in the toner particles is preferably 2 mass % or more, more preferably 3 mass % or more, and still more preferably 4 mass % or more, and is preferably 20 mass % or less, more preferably 15 mass % or less, and still more preferably 10 mass % or less, from the viewpoint of the image density of the printed matter.

The content of the carbon black in the toner particles is preferably 2 parts by mass or more, more preferably 5 parts by mass or more, and still more preferably 7 parts by mass or more relative to 100 parts by mass of the resin A from the viewpoint of obtaining a printed matter having a high image density, and is preferably 20 parts by mass or less, more preferably 15 parts by mass or less, and still more preferably 10 parts by mass or less from the viewpoint of environmental stability.

The toner particles may contain an additional colorant besides the carbon black having the specific BET specific surface area described above as long as the effects of the present invention are not impaired. The content of the additional colorant is preferably 20 mass % or less, more preferably 10 mass % or less, still more preferably 5 mass % or less, still more preferably 3 mass % or less, relative to the total amount of the colorant. Still more preferably, the additional colorant is not contained.

### <Releasing Agent>

The toner particles preferably contain a releasing agent.

Examples of the releasing agent include polypropylene wax, polyethylene wax, ethylene-propylene copolymer wax; hydrocarbon-based waxes such as microcrystalline wax, paraffin wax, and Fischer-Tropsch wax, or oxides thereof; ester-based waxes such as carnauba wax, montan wax, or deacidified wax thereof, and fatty acid ester wax; fatty acid amides, fatty acids, higher alcohols, and fatty acid metal salts. One type or two or more types of these may be used.

The melting point of the releasing agent is preferably 60° C. or higher and more preferably 70° C. or higher, and is preferably 160° C. or lower, more preferably 140° C. or lower, still more preferably 120° C. or lower, and still more preferably 100° C. or lower.

The content of the releasing agent in the toner particles is preferably 0.1 mass % or more, more preferably 1 mass % or more, and still more preferably 3 mass % or more, and is preferably 25 mass % or less, more preferably 21 mass % or less, and still more preferably 17 mass % or less.

In addition, the toner particles may contain an additive such as a charge control agent, a magnetic powder, a fluidity improver, a conductivity modifier, a reinforcing filler such as a fibrous substance, an antioxidant, an anti-aging agent, or a cleaning property improver.

### <Physical Properties of Toner Particles>

The volume median particle size D₅₀ of the toner particles is preferably 2 μm or more, more preferably 3 μm or more, and still more preferably 4 μm or more, and is preferably 10 μm or less, more preferably 8 μm or less, and still more preferably 7 μm or less, from the viewpoint of obtaining a printed coating film having a good image quality and from the viewpoint of further improving the cleaning property of the toner.

The circularity of the toner particles is preferably 0.955 or more, and more preferably 0.960 or more from the viewpoint of obtaining a printed coating film (image) having a good image quality, and is preferably 0.990 or less, more preferably 0.985 or less, and still more preferably 0.980 or less from the viewpoint of the cleaning property.

The CV value of the toner particles is preferably 10% or more, more preferably 12% or more, and still more preferably 14% or more from the viewpoint of improving the productivity of the toner, and is preferably 50% or less, more preferably 45% or less, and still more preferably 40% or less from the viewpoint of achieving good image quality.

The volume median particle size D₅₀ and the CV value of the toner particles can be measured by the method described in Examples.

### Toner Production Method

The toner production method according to an embodiment of the present invention may be any known method such as a melt-kneading method, an emulsion phase inversion method, a suspension polymerization method, and an emulsion aggregation method. An emulsion aggregation method and a melt-kneading method are preferable, and an emulsion aggregation method is more preferable.

### <Emulsion Aggregation Method>

The emulsion aggregation method includes a step of aggregating resin particles containing the resin A and a colorant containing carbon black in an aqueous medium and a step of coalescing the resin particles and the colorant.

### (Step of Aggregating Resin Particles)

In the step of aggregating resin particles, resin particles containing the resin A and carbon black are aggregated in an aqueous medium to produce aggregated particles 1. It is preferable that a resin particle dispersion containing resin particles is mixed with a colorant particle dispersion containing a colorant (carbon black), and these particles are aggregated to produce the aggregated particles 1. When the binder resin contains, besides the resin A, a resin other than the resin A, such as the resin B or the resin C, such an additional resin may be contained in the particles containing the resin A or contained in different particles and may be aggregated. Here, it is preferable to further aggregate a releasing agent in addition to the resin particles and the colorant, and it is more preferable to mix a resin particle dispersion containing resin particles, a colorant particle dispersion containing a colorant, and a releasing agent particle dispersion containing a releasing agent and to aggregate these particles to produce the aggregated particles 1. The resin particle dispersion, the colorant particle dispersion, and the releasing agent particle dispersion are more preferably an aqueous dispersion of resin particles, an aqueous dispersion of colorant particles, and an aqueous dispersion of releasing agent particles, respectively.

In the step of aggregating the resin particles, the aggregated particles 1 may contain an additive such as a charge control agent, a magnetic powder, a fluidity improver, a conductivity modifier, a reinforcing filler such as a fibrous substance, an antioxidant, an anti-aging agent, or a cleaning property improver.

In the present invention, the aqueous medium is a medium containing water as a main component, and the content of water in the aqueous medium is preferably 70 mass % or more, more preferably 80 mass % or more, still more preferably 90 mass % or more, and 100 mass % or less. The water is preferably deionized water or distilled water.

Examples of the component other than water that can form the aqueous medium together with water include organic solvents that dissolve in water, for example, alkyl alcohols having 1 or more and 5 or less carbons; dialkyl ketones having 3 or more and 5 or less carbons, such as acetone and methyl ethyl ketone; and cyclic ethers such as tetrahydrofuran. Among these, an alkyl alcohol having 1 or more and 5 or less carbons is preferable, and ethanol is more preferable.

### «Method for Producing Resin Particle Dispersion»

The resin particles are preferably produced in the form of an aqueous dispersion using an aqueous medium.

Dispersion can be performed using a known method, and it is preferable to disperse the resin particles by using a phase inversion emulsification method. Examples of the phase inversion emulsification method include a method in which an aqueous medium is added to an organic solvent solution of a resin or a molten resin to perform phase inversion emulsification. A method of adding an aqueous medium to an organic solvent solution of a resin to perform phase inversion emulsification is preferable.

The organic solvent used for the phase inversion emulsification is not particularly limited as long as it dissolves a resin and is water-soluble. Examples of the organic solvent include methyl ethyl ketone for the resin A.

A neutralizing agent may be added to the organic solvent solution. Examples of the neutralizing agent include basic substances. Examples of the basic substance include alkali metal hydroxides such as sodium hydroxide and potassium hydroxide; and nitrogen-containing basic substances such as ammonia, trimethylamine, and diethanolamine. Among these, alkali metal hydroxides such as sodium hydroxide and potassium hydroxide are preferable.

The degree of neutralization of the resin constituting the resin particles is preferably 40 mol % or more, more preferably 50 mol % or more, still more preferably 60 mol % or more, and still more preferably 70 mol % or more, and is preferably 100 mol % or less, more preferably 95 mol % or less, and still more preferably 90 mol % or less.

The degree of neutralization of the resin constituting the resin particles can be determined using the following formula.

Degree of neutralization (mol %)=[{mass of neutralizing agent added (g)/equivalent of neutralizing agent}/[{weighted average acid value (mgKOH/g) of resin constituting resin particles×mass (g) of resin constituting resin particles}/(56×1000)]]×100

While an organic solvent solution of a resin or a molten resin is stirred, an aqueous medium is gradually added to the solution or the molten resin to cause phase inversion.

The temperature of the organic solvent solution when the aqueous medium is added is preferably equal to or higher than the glass transition temperature of the resin constituting the resin particles, more preferably 70° C. or higher, still more preferably 75° C. or higher, and is preferably 100° C. or lower, more preferably 95° C. or lower, still more preferably 90° C. or lower, from the viewpoint of improving the dispersion stability of the resin particles.

After the phase inversion emulsification, the organic solvent may be removed from the resultant dispersion through distillation or the like as necessary. The resin particles may be isolated through filtration or the like. It is preferable to use an aqueous dispersion of resin particles obtained by removing the organic solvent from the dispersion produced after the phase inversion emulsification. In this case, the residual amount of the organic solvent in the dispersion is preferably 1 mass % or less, more preferably 0.5 mass % or less, and still more preferably substantially 0 mass %.

The volume median particle size D₅₀ of the resin particles in the dispersion is preferably 0.08 μm or more, more preferably 0.12 μm or more, and is preferably 1 μm or less, more preferably 0.5 μm or less, still more preferably 0.3 μm or less.

The CV value of the resin particles in the dispersion is preferably 10% or more, more preferably 20% or more, and preferably 40% or less, more preferably 35% or less.

The volume median particle size D₅₀ and the CV value of the resin particles in the dispersion are measured by the method described in Examples.

The solid content concentration of the aqueous dispersion of the resin particles is preferably 5 mass % or more, more preferably 10 mass % or more, and still more preferably 15 mass % or more, and is preferably 50 mass % or less, more preferably 45 mass % or less, still more preferably 40 mass % or less, and still more preferably 35 mass % or less, from the viewpoint of improving the productivity of the toner and improving the dispersion stability of the aqueous dispersion of the resin particles.

The solid content is the total amount of nonvolatile components.

### Method for Producing Colorant Particle Dispersion

The colorant particle dispersion is preferably obtained by dispersing a colorant containing carbon black and an aqueous medium using a disperser such as a homomixer, a homogenizer, or an ultrasonic disperser. The dispersion is preferably performed in the presence of a polymer-type pigment dispersant (preferably addition polymer E) or a surfactant from the viewpoint of improving the dispersion stability of the pigment.

The addition polymer E is an addition polymer of raw material monomers containing a styrene-based compound a, from the viewpoint of the image density of the printed matter. That is, the addition polymer E contains a constituent unit derived from the styrene-based compound a in the main chain, from the viewpoint of the image density of the printed matter.

The raw material monomers of the addition polymer E preferably contain an addition polymerizable monomer b having an ionic group (hereinafter, also simply referred to as “monomer b”) in addition to the styrene-based compound a.

Examples of the styrene-based compound a include substituted or unsubstituted styrene. Examples of the substituent with which styrene is substituted include an alkyl group having 1 or more and 5 or less carbons, a halogen atom, an alkoxy group having 1 or more and 5 or less carbons, a sulfo group, or salts thereof.

The molecular weight of the styrene-based compound a is preferably less than 1,000, more preferably 800 or less, and still more preferably 500 or less.

Examples of the styrene-based compound a include styrene, methylstyrene, α-methylstyrene, β-methylstyrene, tert-butylstyrene, chlorostyrene, chloromethylstyrene, methoxystyrene, styrenesulfonic acid, or salts thereof. Among these, styrene and α-methylstyrene are preferable.

A single type of the styrene-based compound a may be used alone or two or more types thereof may be used in combination.

The amount of the styrene-based compound a in the raw material monomers of the addition polymer E is preferably 30 mass % or more, more preferably 50 mass % or more, and still more preferably 60 mass % or more, and is 100 mass % or less, preferably 95 mass % or less, more preferably 90 mass % or less, still more preferably 85 mass % or less, and still more preferably 75 mass % or less, from the viewpoint of the image density of the printed matter.

The ionic group in the monomer b means a group that ionically dissociates in water.

Examples of the ionic group include a carboxy group, a sulfo group, a phosphate group, an amino group, or salts thereof.

The ionic group is preferably an anionic group from the viewpoint of improving the dispersion stability of the colorant particles. The anionic group is preferably an acidic group or a salt thereof, more preferably a carboxy group, a sulfo group, or a salt thereof, and still more preferably a carboxy group or a salt thereof.

Examples of the addition polymerizable monomer having a carboxy group include (meth)acrylic acid, itaconic acid, maleic acid, fumaric acid, and 2-methacryloyloxymethylsuccinic acid.

Among these, an addition polymerizable monomer having an anionic group is preferable, (meth)acrylic acid is more preferable, and acrylic acid is still more preferable.

When the monomer b is contained, the amount of the monomer b in the raw material monomers of the addition polymer E is preferably 5 mass % or more, more preferably 10 mass % or more, still more preferably 15 mass % or more, and still more preferably 25 mass % or more, and is preferably 50 mass % or less, more preferably 40 mass % or less.

In the present invention, the pigment dispersant is preferably a copolymer of the styrene-based compound a and (meth)acrylic acid (styrene acrylic polymer).

Further, the raw material monomer of the addition polymer E may contain an addition polymerizable monomer other than the monomers a and b (additional monomer).

Examples of the additional monomer include addition polymerizable monomers having a polyalkylene oxide group such as polyalkylene glycol (meth)acrylate and methoxypolyethylene glycol (meth)acrylate, styrene-based macromonomers having an addition polymerizable functional group at one terminal, alkyl (meth)acrylates having an alkyl group having 1 or more and 22 or less (preferably 6 or more and 18 or less) carbons, and aromatic group-containing (meth)acrylates. Examples of the aromatic group-containing (meth)acrylate include benzyl (meth)acrylate and phenoxyethyl (meth)acrylate.

When such an additional monomer is contained, the amount of the additional monomer in the raw material monomers of the addition polymer E is preferably 40 mass % or less, more preferably 30 mass % or less, still more preferably 20 mass % or less, still more preferably 10 mass % or less, and still more preferably 5 mass % or less.

The weight average molecular weight of the addition polymer E is preferably 3,000 or more, more preferably 5,000 or more, still more preferably 10,000 or more, and is preferably 100,000 or less, more preferably 50,000 or less, and still more preferably 30,000 or less from the viewpoint of further improving the image density. The weight average molecular weight can be measured by the method described in Examples.

The addition polymer E can be produced by, for example, copolymerizing raw material monomers using a known polymerization method. The polymerization method is preferably a solution polymerization method in which the raw material monomers are heated in a solvent together with a polymerization initiator, a polymerization chain transfer agent, or the like to cause polymerization.

Examples of the polymerization initiator include peroxides such as dibutyl peroxide, persulfates such as sodium persulfate, and azo compounds such as 2,2′-azobis(2,4-dimethylvaleronitrile).

The addition amount of the polymerization initiator is preferably 0.5 parts by mass or more and preferably 10 parts by mass or less relative to 100 parts by mass of the raw material monomers.

Examples of the polymerization chain transfer agent include mercaptans such as 2-mercaptoethanol and 3-mercaptopropionic acid.

The addition amount of the polymerization chain transfer agent is preferably 0.01 parts by mass or more, and preferably 3 parts by mass or less relative to 100 parts by mass of the raw material monomers.

After completion of the polymerization reaction, the produced polymer may be isolated and purified from the reaction solution by a known method such as reprecipitation or solvent distillation.

The mass ratio of the colorant (carbon black) to the addition polymer E (colorant/addition polymer E) in the colorant particle dispersion is preferably 50/50 or more, more preferably 55/45 or more, still more preferably 60/40 or more, still more preferably 65/35 or more, and is preferably 95/5 or less, more preferably 90/10 or less, from the viewpoint of the chargeability of the toner and the image density of the printed matter.

Examples of the surfactant that improves the dispersion stability of the pigment include a nonionic surfactant, an anionic surfactant, and a cationic surfactant. From the viewpoint of improving the dispersion stability of the pigment, a nonionic surfactant is preferable. Examples of the nonionic surfactant include polyoxyalkylene alkyl ethers, polyoxyalkylene alkenyl ethers, and polyoxyalkylene aryl ethers. Among these, polyoxyethylene aryl ethers are preferable, and polyoxyethylene distyrenated phenyl ethers are more preferable.

The mass ratio of the colorant (carbon black) to the surfactant (colorant/surfactant) in the colorant particle dispersion is preferably 50/50 or more, more preferably 55/45 or more, still more preferably 60/40 or more, still more preferably 65/35 or more, and preferably 95/5 or less, more preferably 90/10 or less, from the viewpoint of the chargeability of the toner and the image density of the printed matter.

In the colorant particle dispersion, the amount of the pigment is preferably 5 mass % or more and more preferably 10 mass % or more, and is preferably 50 mass % or less, more preferably 40 mass % or less, still more preferably 30 mass % or less, and still more preferably 25 mass % or less.

The solid content concentration of the colorant particle dispersion is preferably 5 mass % or more, more preferably 10 mass % or more, and still more preferably 15 mass % or more, and is preferably 50 mass % or less, more preferably 40 mass % or less, and still more preferably 30 mass % or less.

The volume median particle size D₅₀ of the colorant particles is preferably 0.02 μm or more, more preferably 0.04 μm or more, and still more preferably 0.06 μm or more, and is preferably 0.20 μm or less, more preferably 0.15 μm or less, and still more preferably 0.10 μm or less, from the viewpoint of improving the dispersibility in the toner particles.

The CV value of the colorant particles is preferably 10% or more, more preferably 20% or more, and is preferably 40% or less, more preferably 35% or less, still more preferably 30% or less, from the viewpoint of improving the dispersibility in the toner particles.

The volume median particle size D₅₀ and the CV value of the colorant particles are measured by the methods described in Examples.

### «Method for Producing Releasing Agent Particle Dispersion»

The releasing agent particle dispersion is produced by, for example, dispersing a releasing agent, the resin particle dispersion described above, and an aqueous medium as necessary at a temperature equal to or higher than the melting point of the releasing agent using a disperser such as a homogenizer, a high-pressure disperser, or an ultrasonic disperser.

The heating temperature at the time of dispersion is preferably equal to or higher than the melting point of the releasing agent and 80° C. or higher, more preferably 85° C. or higher, still more preferably 90° C. or higher, and is preferably 100° C. or lower, more preferably 98° C. or lower, and still more preferably 96° C. or lower.

The releasing agent particle dispersion can be produced using a surfactant, but is preferably produced by mixing a releasing agent and the above-described resin particles. When the releasing agent particles are prepared using the releasing agent and the resin particles, the releasing agent particles can be stabilized with the resin particles, and the releasing agent can be dispersed in the aqueous medium without using a surfactant. It is considered that the releasing agent particle dispersion has a structure in which a large number of resin particles are attached to the surfaces of the releasing agent particles.

The resin constituting the resin particles in which the releasing agent is to be dispersed is preferably a polyester-based resin. It is more preferable to use the amorphous polyester resin A described above.

The volume median particle size D₅₀ of the releasing agent particles in the releasing agent particle dispersion is preferably 0.05 μm or more, more preferably 0.1 μm or more, still more preferably 0.15 μm or more, and is preferably 1 μm or less, more preferably 0.8 μm or less, still more preferably 0.5 μm or less, from the viewpoint of obtaining uniform aggregated particles through aggregation.

The CV value of the releasing agent particles in the releasing agent particle dispersion is preferably 10% or more, more preferably 20% or more, and is preferably 50% or less, more preferably 35% or less, still more preferably 30% or less.

The volume median particle size D₅₀ and the CV value of the releasing agent particles in the releasing agent particle dispersion are measured by the methods described in Examples.

### —Surfactant—

In the step of aggregating the resin particles, the dispersions of respective particles may be mixed to prepare a mixed dispersion in the presence of a surfactant, from the viewpoint of improving the dispersion stability of the resin particles, the releasing agent particles, the colorant particles, and the like. Examples of the surfactant include anionic surfactants such as alkylbenzene sulfonate and alkyl ether sulfate; and nonionic surfactants such as polyoxyethylene alkyl ethers and polyoxyethylene alkenyl ethers.

When a surfactant is used, the total amount of the surfactant to be used is preferably 0.1 parts by mass or more, more preferably 0.3 parts by mass or more, and still more preferably 0.5 parts by mass or more, and is preferably 10 parts by mass or less, more preferably 5 parts by mass or less, and still more preferably 3 parts by mass or less, relative to 100 parts by mass of the binder resin in the aggregated particles 1.

### —Aggregating Agent—

In the step of aggregating the resin particles, it is preferable to add an aggregating agent from the viewpoint of efficiently performing aggregation.

Examples of the aggregating agent include cationic surfactants such as quaternary salts, organic aggregating agents such as polyethyleneimine, and inorganic aggregating agents. Examples of the inorganic aggregating agent include inorganic metal salts such as sodium sulfate, sodium nitrate, sodium chloride, calcium chloride, and calcium nitrate; inorganic ammonium salts such as ammonium sulfate, ammonium chloride, and ammonium nitrate; and divalent or higher-valent metal complexes.

From the viewpoint of improving the aggregability and producing uniform aggregated particles 1, an inorganic aggregating agent having a valence of 1 or more and 5 or less is preferable, an inorganic metal salt or an inorganic ammonium salt having a valence of 1 or more and 2 or less is more preferable, an inorganic ammonium salt is still more preferable, and ammonium sulfate is still more preferable.

When an aggregating agent is used, for example, the aggregating agent is added in an amount of 25 parts by mass or more and 50 parts by mass or less relative to 100 parts by mass of the binder resin in the aggregated particles 1 to a mixed dispersion containing the resin particles, the releasing agent particles, and the colorant particles at 0° C. or higher and 40° C. or lower, and the resin particles, the releasing agent particles, and the colorant particles are aggregated in the aqueous medium, to produce the aggregated particles 1. Further, it is preferable to increase the temperature of the dispersion after addition of the aggregating agent from the viewpoint of promoting aggregation.

Examples of the method for terminating aggregation include a method of cooling the dispersion, a method of adding an aggregation stopping agent, and a method of diluting the dispersion. A method of adding an aggregation stopping agent to terminate aggregation is preferable from the viewpoint of reliably preventing unnecessary aggregation.

### —Aggregation Stopping Agent—

The aggregation stopping agent is preferably a surfactant, and is more preferably an anionic surfactant. Examples of the anionic surfactant include an alkylbenzene sulfonate, an alkyl sulfate, an alkyl ether sulfate, a polyoxyalkylene alkyl ether sulfate, an aryl sulfonate, and an aryl sulfonate formalin condensate. An alkali metal salt of an aryl sulfonate formalin condensate is preferable, and a sodium salt of a β-naphthalene sulfonate formalin condensate is more preferable. One type or two or more types of these may be used. The aggregation stopping agent may be added in the form of an aqueous solution.

The addition amount of the aggregation stopping agent is preferably 10 parts by mass or more and more preferably 15 parts by mass or more relative to 100 parts by mass of the binder resin in the aggregated particles 1, from the viewpoint of reliably preventing unnecessary aggregation, and is preferably 45 parts by mass or less, more preferably 40 parts by mass or less, and still more preferably 35 parts by mass or less, from the viewpoint of reducing residues in the toner.

The volume median particle size D₅₀ of the aggregated particles 1 is preferably 2 μm or more, more preferably 3 μm or more, and still more preferably 4 μm or more, and is preferably 10 μm or less, more preferably 8 μm or less, and still more preferably 7 μm or less.

In the present invention, after the step of aggregating the resin particles and before the coalescing step, a step of attaching resin particles for shell containing the amorphous resin to the resultant aggregated particles 1 and aggregating the particles to produce aggregated particles 2 may be included. Toner particles having a core-shell structure can be produced by including the step of aggregating the resin particles for shell.

The resin particles for shell are preferably an amorphous resin, more preferably an amorphous polyester-based resin, and still more preferably at least one selected from the resin A and the resin B described above.

A dispersion of the resin particles for shell is produced by the above-described method for producing a resin particle dispersion.

When the toner production method includes the step of aggregating the resin particles for shell, the aggregation is preferably terminated when the aggregated particles 2 are grown to an appropriate particle size as toner particles in the step, and a method of terminating the aggregation by adding the above-described aggregation stopping agent is preferable.

The ratio of the mass of the resin particles for shell to the mass of the aggregated particles 1 [resin particles for shell/aggregated particles 1] is preferably 1/99 or more, more preferably 3/97 or more, and still more preferably 5/95 or more, and is preferably 25/75 or less, more preferably 20/80 or less, and still more preferably 15/85 or less, from the viewpoint of the low-temperature fusing property of the toner.

### (Coalescing Step)

In the coalescing step, for example, the aggregated particles 1 or the aggregated particles 2 are coalesced in an aqueous medium.

Through the coalescing, the particles contained in the aggregated particles 1 or the aggregated particles 2 are coalesced together to produce coalesced particles.

In the coalescing step, the coalescing temperature is maintained at a temperature equal to or higher than the glass transition temperature of the resin having the highest glass transition temperature among the amorphous polyester-based resins contained in the aggregated particles, from the viewpoint of improving the coalescing property of the aggregated particles 1 or the aggregated particles 2 and from the viewpoint of improving the low-temperature fusing property of the toner.

The holding (heating) temperature at the time of coalescing the aggregated particles is preferably 100° C. or lower from the viewpoint of improving the productivity of the toner. The holding temperature is 100° C. or lower and preferably not lower than a temperature higher by 2° C. than the maximum value of glass transition temperatures of the resin(s) among the amorphous polyester-based resins, and more preferably not lower than a temperature higher by 3° C. than the maximum value of glass transition temperatures. The holding temperature is also preferably not higher than a temperature higher by 30° C. than the maximum value of glass transition temperatures of the resin(s) among the amorphous polyester-based resins, more preferably not higher than a temperature higher by 25° C. than the maximum value of glass transition temperatures, and even more preferably not higher than a temperature higher by 20° C. than the maximum value of glass transition temperatures.

In this case, the time for holding the amorphous polyester-based resin at a temperature equal to or higher than the glass transition temperature is preferably 1 minute or more, more preferably 10 minutes or more, and still more preferably 30 minutes or more, and is preferably 240 minutes or less, more preferably 180 minutes or less, still more preferably 120 minutes or less, and still more preferably 90 minutes or less, from the viewpoint of improving the low-temperature fusing property of the toner.

Preferably, the temperature is held as described above until a desired circularity is achieved.

The volume median particle size D₅₀ of the coalesced particles produced through the coalescing is preferably 2 μm or more, more preferably 3 μm or more, and still more preferably 4 μm or more, and is preferably 10 μm or less, more preferably 8 μm or less, and still more preferably 7 μm or less.

The circularity of the coalesced particles produced through the coalescing is preferably 0.955 or more, and more preferably 0.960 or more, and is preferably 0.990 or less, more preferably 0.985 or less, and still more preferably 0.980 or less.

It is preferable that the coalescing is completed after the aforementioned preferable circularity is achieved.

The circularity is measured by the method described in Examples.

### (Post-Treatment Step)

A post-treatment step may be performed after the coalescing step, and toner particles are produced by isolating the coalesced particles. Since the coalesced particles produced in the coalescing step are present in an aqueous medium, it is preferable to first perform solid-liquid separation. For the solid-liquid separation, a suction filtration method or the like is preferably used.

Washing is preferably performed after the solid-liquid separation. In this case, since it is preferable to remove the added surfactant, it is preferable to perform washing with an aqueous medium at a temperature equal to or lower than the cloud point of the surfactant. The washing is preferably performed a plurality of times.

Subsequently, drying is preferably performed. Examples of the drying method include vacuum constant-temperature drying, vibration type fluidized drying, spray drying, freeze-drying method, and flush jetting.

### <Melt-Kneading Method>

In the present invention, the melt-kneading method is performed, for example, by uniformly mixing the binder resin, the colorant and, as necessary, an additive such as a releasing agent with a mixer such as a Henschel mixer, and then melt-kneading the mixture with a closed kneader, a single-screw or twin-screw extruder, an open-roll kneader, or the like. Subsequently, toner particles can be produced by cooling, pulverization, and classification.

The toner contains toner particles. The produced toner particles can be used as they are as the toner of the present invention. Preferably, a toner obtained by adding an external additive to the surfaces of the toner particles is used as the toner of the present invention.

### <External Additive>

Examples of the external additive include fine particles of an inorganic material such as hydrophobic silica, titanium oxide, alumina, cerium oxide, or carbon black, and fine particles of a polymer such as polycarbonate, polymethyl methacrylate, or a silicone resin. Among these, hydrophobic silica is preferable. A single type of external additive may be used alone, or two or more types thereof may be used. Two or more types of hydrophobic silica having different particle sizes may also be used.

When the surface treatment is performed on the toner particles using an external additive, the addition amount of the external additive is preferably 1 part by mass or more, more preferably 2 parts by mass or more, and still more preferably 3 parts by mass or more, and is preferably 5 parts by mass or less, more preferably 4.5 parts by mass or less, and still more preferably 4 parts by mass or less, relative to 100 parts by mass of the toner particles.

The toner is used for electrostatic image development in electrophotographic printing. The toner can be used, for example, in the form of a one-component developer or a two-component developer mixed with a carrier.

<1>

A toner for electrostatic image development, containing a binder resin and a colorant, wherein
the binder resin contains an amorphous polyester resin A having an ester group concentration of 5.0 mmol/g or more and 15.0 mmol/g or less, and
the colorant contains carbon black having a BET specific surface area of 200 m²/g or more.
   <2>

The toner for electrostatic image development according to <1>, wherein the amorphous polyester resin A is a polycondensate of an alcohol component (a) and a carboxylic acid component (b), and the alcohol component (a) contains a linear or branched aliphatic diol having 2 or more and 6 or less carbons.

<3>

The toner for electrostatic image development according to <1> or <2>, wherein the aliphatic diol contains at least one selected from 1,2-propanediol, neopentyl glycol, 2-ethyl-2-methyl-1,3-propanediol, 2,2-dimethyl-1,4-butanediol, and 3-methyl-1,5-pentanediol, preferably contains at least one selected from 1,2-propanediol, neopentyl glycol, and 3-methyl-1,5-pentanediol, and more preferably contains at least one selected from 1,2-propanediol and neopentyl glycol.

<4>

The toner for electrostatic image development according to <2> or <3>, wherein the content of the aliphatic diol in the alcohol component (a) is 80 mol % or more, preferably 85 mol % or more, more preferably 90 mol % or more, and 100 mol % or less.

<5>

The toner for electrostatic image development according to any of <2> to <4>, wherein the carboxylic acid component (b) contains an aromatic dicarboxylic acid, preferably at least one selected from terephthalic acid and isophthalic acid, and more preferably terephthalic acid and isophthalic acid.

<6>

The toner for electrostatic image development according to any of <2> to <5>, wherein the content of the aromatic dicarboxylic acid in the carboxylic acid component (b) is 60 mol % or more, preferably 70 mol % or more, more preferably 80 mol % or more, and 100 mol % or less.

<7>

The toner for electrostatic image development according to any of <1> to <6>, wherein the ester group concentration of the amorphous polyester resin A is 5.5 mmol/g or more, preferably 6.0 mmol/g or more, and 13.0 mmol/g or less, preferably 12.0 mmol/g or less.

<8>

The toner for electrostatic image development according to any of <1> to <9>, wherein the binder resin contains a crystalline polyester resin C.

<9>

The toner for electrostatic image development according to <8>, wherein the crystalline polyester resin C is a polycondensate of an alcohol component and a carboxylic acid component, and the alcohol component contains an α,ω-aliphatic diol.

<10>

The toner for electrostatic image development according to <9>, wherein the carbon number of the α,ω-aliphatic diol is 2 or more and 16 or less, preferably 14 or less, and more preferably 12 or less.

<11>

The toner for electrostatic image development according to <9> or <10>, wherein the α,ω-aliphatic diol contains at least one selected from ethylene glycol, 1,6-hexanediol, 1,10-decanediol, and 1,12-dodecanediol, preferably ethylene glycol and 1,10-decanediol, and more preferably ethylene glycol.

<12>

The toner for electrostatic image development according to any of <9> to <11>, wherein the carboxylic acid component contains an aliphatic dicarboxylic acid.

<13>

The toner for electrostatic image development according to <12>, wherein the carbon number of the aliphatic dicarboxylic acid is 4 or more, preferably 8 or more, more preferably 10 or more, and 14 or less, preferably 12 or less.

<14>

The toner for electrostatic image development according to <12> or <13>, wherein the aliphatic dicarboxylic acid contains at least one selected from fumaric acid, sebacic acid, dodecanedioic acid, and tetradecanedioic acid, preferably at least one selected from sebacic acid and dodecanedioic acid, and more preferably dodecanedioic acid.

<15>

The toner for electrostatic image development according to any of <8> to <14>, wherein the crystalline polyester resin C has an ester group concentration of 5.0 mmol/g or more, preferably 6.0 mmol/g or more, more preferably 7.0 mmol/g or more, and 12.0 mmol/g or less, 11.0 mmol/g or less, and still more preferably 10.0 mmol/g or less.

<16>

The toner for electrostatic image development according to any of <8> to <15>, wherein the weighted average of ester group concentrations of the amorphous polyester resin A and the crystalline polyester resin C is 5.0 mmol/g or more, preferably 5.5 mmol/g or more, more preferably 6.0 mmol/g or more, and 15.0 mmol/g or less, preferably 13.0 mmol/g or less, more preferably 12.0 mmol/g or less.

<17>

The toner for electrostatic image development according to any of <8> to <16>, wherein the mass ratio of the crystalline polyester resin C to the amorphous polyester resin A [crystalline polyester resin C/amorphous polyester resin A] is 5/95 or more, preferably 10/90 or more, more preferably 15/85 or more, and 40/60 or less, preferably 30/70 or less, more preferably 25/75 or less.

<18>

The toner for electrostatic image development according to any of <1> to <17>, wherein the carbon black contains at least one selected from furnace black, thermal lamp black, acetylene black, and channel black, preferably furnace black.

<19>

The toner for electrostatic image development according to any of <1> to <18>, wherein the carbon black has a pH value of 5.0 or more, preferably 6.0 or more, more preferably 7.0 or more, and 10.0 or less, preferably 9.0 or less, more preferably 8.5 or less.

<20>

The toner for electrostatic image development according to any of <1> to <19>, wherein the carbon black has a dibutyl phthalate oil absorption of 30 ml/100 g or more, preferably 60 ml/100 g or more, more preferably 100 ml/100 g or more, and 160 ml/100 g or less, preferably 140 ml/100 g or less, more preferably 125 ml/100 g or less.

<21>

The toner for electrostatic image development according to any of <1> to <20>, wherein the carbon black has a BET specific surface area of 205 m²/g or more, preferably 210 m²/g or more, and 290 m²/g or less, preferably 275 m²/g or less, more preferably 260 m²/g or less, and still more preferably 250 m²/g or less.

<22>

The toner for electrostatic image development according to any of <1> to <21>, wherein the toner for electrostatic image development contains toner particles, and the content of carbon black in the toner particles is 2 mass % or more, preferably 3 mass % or more, more preferably 4 mass % or more, and 20 mass % or less, preferably 15 mass % or less, more preferably 10 mass % or less.

<23>

The toner for electrostatic image development according to any of <1> to <22>, wherein the toner for electrostatic image development contains toner particles, and the content of carbon black in the toner particles is 2 parts by mass or more, preferably 5 parts by mass or more, more preferably 7 parts by mass or more, and 20 parts by mass or less, preferably 15 parts by mass or less, more preferably 10 parts by mass or less, relative to 100 parts by mass of the amorphous polyester resin A.

<24>

A method for producing the toner for electrostatic image development described in any of <1> to <23>, including aggregating and coalescing resin particles and colorant particles, wherein
the resin particles contain an amorphous polyester resin A having an ester group concentration of 5.0 mmol/g or more and 15.0 mmol/g or less, and
the colorant particles contain carbon black having a BET specific surface area of 200 m²/g or more.
   <25>

The method for producing the toner for electrostatic image development according to <24>, wherein a heating temperature in the coalescing is 100° C. or lower.

<26>

The method for producing the toner for electrostatic image development according to <24> or <25>, including preparing a colorant particle dispersion containing carbon black having a BET specific surface area of 200 m²/g or more by using an addition polymer E or a surfactant that are pigment dispersants.

<27>

The method for producing the toner for electrostatic image development according to <26>, wherein, in the colorant particle dispersion, the mass ratio of the carbon black to the addition polymer E (carbon black/addition polymer E) is 50/50 or more, preferably 55/45 or more, more preferably 60/40 or more, still more preferably 65/35 or more, and 95/5 or less, preferably 90/10 or less.

<28>

The method for producing the toner for electrostatic image development according to <26>, wherein, in the colorant particle dispersion, the mass ratio of the carbon black to the surfactant (carbon black/surfactant) is 50/50 or more, preferably 55/45 or more, more preferably 60/40 or more, still more preferably 65/35 or more, and 95/5 or less, preferably 90/10 or less.

### EXAMPLES

Hereinafter, the present invention will be specifically described with reference to Examples, but the present invention is not limited in any way by these Examples. The respective property values were measured and evaluated by the following methods.

In the description such as “alkylene oxide (X)”, the numerical value X in parentheses means the number of moles added of alkylene oxide.

### [Measurement Method]

### [Acid Value of Resin]

The acid value of a resin was measured in accordance with the neutralization titration method described in JIS K 0070:1992. The measurement solvent was chloroform.

### [Softening Point, Crystallinity Index, and Glass Transition Temperature of Resin]

### (1) Softening Point

By using a flow tester “CFT-500D” (available from Shimadzu Corporation), while 1 g of a sample was heated at a temperature rising rate of 6° C./min, a load of 1.96 MPa was applied with a plunger, and the sample was extruded from a nozzle having a diameter of 1 mm and a length of 1 mm. The plunger descending amount of the flow tester was plotted against the temperature, and the temperature at which half of the sample flowed out was defined as the softening point.

### (2) Crystallinity Index

By using a differential scanning calorimeter “Q100” (available from TA Instruments Japan Inc.), 0.02 g of a sample was weighed in an aluminum pan, and cooled to 0° C. at a temperature falling rate of 10° C./min. Subsequently, the sample was allowed to stand still for 1 minute, then heated to 180° C. at a temperature rising rate of 10° C./min, and the amount of heat was measured. The crystallinity index was determined by (softening point (° C.))/(maximum endothermic peak temperature (1) (° C.)), wherein the temperature of the peak having the largest peak area among the endothermic peaks observed was defined as the maximum endothermic peak temperature (1).

### (3) Glass Transition Temperature

By using a differential scanning calorimeter “Q100” (available from TA Instruments Japan Inc.), 0.02 g of a sample was weighed in an aluminum pan, and the temperature was increased to 200° C., and then cooled to 0° C. at a temperature falling rate of 10° C./min. Subsequently, the sample was heated at a temperature rising rate of 10° C./min, and the amount of heat was measured. The temperature of the peak having the largest peak area among the endothermic peaks observed was defined as the maximum endothermic peak temperature (2).

In the case of a crystalline resin, the peak temperature was taken as the melting point. In the case of an amorphous resin, when a peak was observed, the temperature of the peak was defined as the glass transition temperature, whereas when a stepped portion was observed without observation of a peak, the temperature at the intersection between the tangent indicating the maximum inclination of the curve of the stepped portion and the extended line of the baseline on the low temperature side of the stepped portion was defined as the glass transition temperature.

### [Weight Average Molecular Weight of Pigment Dispersant]

An eluent was prepared by dissolving phosphoric acid and lithium bromide in N,N-dimethylformamide at concentrations of 43 mmol/L and 50 mmol/L, respectively, and the weight average molecular weight was measured by a gel permeation chromatography method [GPC device (HLC-8320GPC) available from Tosoh Corporation, columns (TSKgel SuperAWM-H, TSKgel SuperAW3000, TSKgel guardcolum SuperAW-H) available from Tosoh Corporation, flow rate: 0.5 mL/min] using, as a standard substance, a monodisperse polystyrene kit [PStQuick B (F-550, F-80, F-10, F-1, A-1000), PStQuick C (F-288, F-40, F-4, A-5000, A-500), available from Tosoh Corporation] having a known molecular weight.

The measurement sample used was prepared as follows: 0.1 g of a polymer was mixed with 10 mL of the aforementioned eluent in a glass vial, and the mixture was stirred with a magnetic stirrer at 25° C. for 10 hours, and then filtered through a syringe filter (DISMIC-13HP PTFE 0.2 μm, available from ADVANTEC).

### [Acid Value of Pigment Dispersant]

Measurement was performed in accordance with the potentiometric titration method described in JIS K 0070:1992.

### [Melting Point of Releasing Agent]

By using a differential scanning calorimeter “Q100” (available from TA Instruments Japan Inc.), 0.02 g of a sample was weighed in an aluminum pan, and the temperature was increased to 200° C., and then cooled to 0° C. at a temperature falling rate of 10° C./min. Subsequently, the sample was heated at a temperature rising rate of 10° C./min, the amount of heat was measured, and the maximum endothermic peak temperature was defined as the melting point.

### [Volume Median Particle Size D₅₀ and CV Value of Resin Particles, Releasing Agent Particles, and Colorant Particles]

(1) Measurement device: laser diffraction particle size analyzer “LA-920” (available from HORIBA, Ltd.)
(2) Measurement conditions: a sample dispersion was put in a measurement cell, distilled water was added thereto, and a volume median particle size D₅₀ and a volume average particle size Dv were measured at a concentration at which the absorbance was in an appropriate range. The CV value (particle size distribution) was calculated according to the following formula.

$$CV value ( \% ) = ( standard deviation of particle size distribution / volume average particle size {D}_{V} ) \times 100$$

### [Solid Content Concentration of Resin Particle Dispersion, Colorant Particle Dispersion, and Releasing Agent Particle Dispersion]

The water content (mass %) of 5 g of the measurement sample was measured at a drying temperature of 150° C. and a measurement mode of 96 (monitoring time: 2.5 min/fluctuation range: 0.05%) using an infrared moisture meter “FD-230” (available from Kett Electric Laboratory Co. Ltd). The solid content concentration was calculated according to the following formula.

$$Solid content concentration ( mass \% ) = 100 - water content ( mass \% )$$

### [Volume Median Particle Size D₅₀ of Aggregated Particles]

Measuring instrument: “Coulter Multisizer (registered trademark) III” (available from Beckman Coulter, Inc.)
Aperture diameter: 50 μm
Analysis software: “Multisizer (registered trademark) III version 3.51” (available from Beckman Coulter, Inc.)
Electrolytic solution: “ISOTON (registered trademark) II” (available from Beckman Coulter, Inc.)
Measurement conditions: the sample dispersion was added to 100 mL of the electrolytic solution to adjust the concentration so that the particle size of 30000 particles was able to be measured in 20 seconds. Then, 30000 particles were subjected to the measurement, and the volume median particle size D₅₀ was determined from the particle size distribution.

### [Circularity of Coalesced Particles]

Measurement device: flow-type particle image analyzer “FPIA-3000” (available from Sysmex Corporation)
Preparation of dispersion: a dispersion of coalesced particles was diluted with deionized water so as to have a solid content concentration of 0.001 to 0.05 mass %.
Measurement mode: HPF measurement mode

### [Volume Median Particle Size D₅₀ and CV Value of Toner Particles]

The measuring instrument, the aperture diameter, the analysis software, and the electrolytic solution were the same as those used in the measurement of the volume median particle size D₅₀ of the aggregated particles described above.
Dispersion: polyoxyethylene lauryl ether “EMULGEN (registered trademark) 109P” (available from Kao Corporation, HLB (Hydrophile-Lipophile Balance): 13.6) was dissolved in the electrolytic solution to prepare a dispersion having a concentration of 5 mass %.
Dispersion conditions: 10 mg of a measurement sample of toner particles was added to 5 mL of the dispersion and dispersed for 1 minute with an ultrasonic disperser, and then 25 mL of the electrolytic solution was added and further dispersed for 1 minute with the ultrasonic disperser to prepare a sample dispersion.
Measurement conditions: the sample dispersion was added to 100 mL of the electrolytic solution to adjust the concentration so that the particle size of 30000 particles was able to be measured in 20 seconds. Then, 30000 particles were subjected to the measurement, and the volume median particle size D₅₀ and the volume average particle size Dv were determined from the particle size distribution.

The CV value (%) was calculated according to the following formula.

$$CV value ( \% ) = ( standard deviation of particle size distribution / volume average particle size {D}_{V} ) \times 100$$

### [BET Specific Surface Area]

The BET specific surface area of carbon black was measured in accordance with “Method for Determining Specific Surface Area” of JIS K 6217-2:2017. A multi-sample high performance specific surface area/pore distribution measuring device “3FLEX” (available from Shimadzu Corporation) was used as the measurement device, and 1.0 g of a sample was measured by using a capacity method as the detection method and a multi-point method as the measurement method.

### [Production of Resin]

### [Production of Amorphous Polyester Resin A]

### Production Example A1 (Production of Resin A-1)

Neopentyl glycol, terephthalic acid, and tin(II) di(2-ethylhexanoate) shown in Table 1 were placed in a 10 L four-necked flask equipped with a thermometer, a stainless steel stirring rod, a dehydration tube, a cooling tube, and a nitrogen introduction tube, the temperature was increased to 180° C. in a mantle heater in a nitrogen atmosphere, and the reaction was performed for 2 hours. Thereafter, the temperature was increased to 210° C. at a rate of 5° C./h. After cooling to 180° C., isophthalic acid shown in Table 1 was added, the temperature was increased again to 190° C., the reaction was performed for 1 hour, and then the temperature was increased to 220° C. at a rate of 10° C./h. Thereafter, the reaction was performed at 13.3 kPa up to the softening point shown in Table 1 to produce a resin A-1. The physical property values are shown in Table 1.

### Production Example A2 (Production of Resin A-2)

The raw material monomers of a polyester resin other than fumaric acid shown in Table 1 and tin(II) di(2-ethylhexanoate) were placed in a 10 L four-necked flask equipped with a nitrogen introduction tube, a dehydration tube, a stirrer, and a thermocouple. In a nitrogen atmosphere, the reaction system was held at 210° C. for 1 hour, then heated from 210° C. to 220° C. at 10° C./h, and then held at 220° C. for 3 hours for polycondensation. Then, after cooling to 190° C., fumaric acid and 4-tert-butylcatechol were added to the reaction system, the temperature was increased from 190° C. to 220° C. at 10° C./h, the reaction was performed at 220° C. for 5 hours, and the reaction was performed at 220° C. and 10 kPa up to the softening point shown in Table 1 to produce a resin A-2. The physical property values are shown in Table 1.

### Production Example B1 (Production of Resin B-1)

The interior of a four-necked flask equipped with a nitrogen introduction tube, a dehydration tube, a stirrer, and a thermocouple was purged with nitrogen, the raw material monomers of a polyester resin other than trimellitic anhydride shown in Table 1 and tin(II) di(2-ethylhexanoate) were added, the temperature was increased to 235° C. in a nitrogen atmosphere with stirring, and the mixture was held at 235° C. for 6 hours. Then, the pressure in the flask was further reduced, and the mixture was held at 8.3 kPa for 1 hour. Thereafter, the flask was cooled to 215° C. and returned to atmospheric pressure, then trimellitic anhydride shown in Table 1 was added, the mixture was held at 215° C. for 1 hour, then the pressure in the flask was further reduced, and the reaction was performed at 8.3 kPa up to the softening point shown in Table 1 to produce a resin B-1. The physical property values are shown in Table 1.

TABLE 1

| | | | Production Example | | | | | |
|---|---|---|---|---|---|---|---|---|
| | | | Production Example A1 | | Production Example A2 | | Production Example B1 | |
| Resin | | | A-1 | | A-2 | | B-1 | |
| Raw material | | | Charged | Parts by | Charged | Parts by | Charged | Parts by |
| monomers of | | | amount (g) | mol *1 | amount (g) | mol *1 | amount (g) | mol *1 |
| polyester | Alcohol | 1,2-propanediol | — | — | 3147 | 100 | — | — |
| resin | component | Neopentyl glycol | 3887 | 100 | — | — | — | — |
| | | BPA-PO *2 | — | — | — | — | 3880 | 70 |
| | | BPA-EO *3 | — | — | — | — | 1544 | 30 |
| | Acid component | Terephthalic acid | 3686 | 59 | 5773 | 84 | 1578 | 60 |
| | | Isophthalic acid | 2027 | 33 | — | — | — | — |
| | | Fumaric acid | — | — | 480 | 10 | — | — |
| | | Adipic acid | — | — | — | — | 694 | 30 |
| | | Trimellitic anhydride | — | — | — | — | 304 | 10 |

| Esterification | Tin(II) di(2-ethylhexanoate) (g) | 19 | 50 | 40 |
|---|---|---|---|---|
| catalyst | | | | |
| Radical | 4-tert-butylcatechol (g) | — | 5 | — |
| polymerization | | | | |
| inhibitor | | | | |

| | | | | |
|---|---|---|---|---|
| Physical | Ester group concentration (mmol/g) | 8.2 | 10.3 | 4.3 |
| properties | Softening point (° C.) | 105 | 110 | 114 |
| | Glass transition temperature (° C.) | 58 | 67 | 56 |
| | Crystallinity index | 1.7 | 1.7 | 1.8 |
| | Acid value (mgKOH/g) | 19 | 19 | 19 |

*1: Parts by mol of each monomer relative to 100 parts by mol of the alcohol component of the raw material monomers of the polyester resin.
*2: Polyoxypropylene(2.2)-2,2-bis(4-hydroxyphenyl)propane
*3: Polyoxyethylene(2.0)-2,2-bis(4-hydroxyphenyl)propane

### [Production of Crystalline Polyester Resin (C)]

### Production Example C1 (Production of Resin C-1)

The interior of a 10 L four-necked flask equipped with a nitrogen introduction tube, a dehydration tube, a stirrer, and a thermocouple was purged with nitrogen, the raw material monomers of a polyester resin shown in Table 2 were added, the temperature of the reaction system was increased to 135° C. with stirring, the reaction system was held at 135° C. for 3 hours, and then the temperature was increased from 135° C. to 200° C. over 10 hours. Thereafter, 23 g of tin(II) di(2-ethylhexanoate) was added to the reaction system, and the reaction system was further held at 200° C. for 1 hour, then the pressure in the flask was reduced, and the reaction system was held under a reduced pressure of 8 kPa for 1 hour to produce a resin C-1. The physical property values are shown in Table 2.

TABLE 2

| Production Example | | | C1 | |
|---|---|---|---|---|
| Resin | Type of resin | | Crystalline polyester resin | |
| | Resin number | | C-1 | |
| | | | Charged amount (g) | Parts by mol*¹ |
| Raw material monomers | Alcohol component | Ethylene glycol | 1556 | 100 |
| | Carboxylic acid component | Dodecanedioic acid | 5944 | 103 |

| | | |
|---|---|---|
| Esterification catalyst | Tin(II) di(2-ethylhexanoate) (g) | 23 |
| Physical properties | Ester group concentration (mmol/g) | 7.5 |
| | Softening point (° C.) | 86 |
| | Melting point (° C.) | 84 |
| | Crystallinity index | 1.0 |
| | Acid value (mgKOH/g) | 17 |

*¹Parts by mol of each monomer relative to 100 parts by mol of the alcohol component of the raw material monomers.

### [Production of Pigment Dispersant (Addition Polymer E)]

A monomer mixed liquid was prepared by mixing 61.6 parts by mass of acrylic acid, 128.8 parts by mass of styrene, and 9.6 parts by mass of α-methylstyrene. 20 parts by mass of methyl ethyl ketone, 0.3 parts by mass of 2-mercaptoethanol as a polymerization chain transfer agent, and 10 mass % of the monomer mixed liquid were charged into a reaction container and mixed, and the container was sufficiently purged with nitrogen gas. Meanwhile, a mixed liquid containing the remaining 90 mass % of the monomer mixed liquid, 0.27 parts by mass of the polymerization chain transfer agent, 60 parts by mass of methyl ethyl ketone, and 2.2 parts by mass of an azo-based radical polymerization initiator (2,2′-azobis(2,4-dimethylvaleronitrile)) was charged into a dropping funnel, the temperature of the monomer mixed liquid in the reaction container was increased to 65° C. with stirring in a nitrogen atmosphere, and the mixed liquid in the dropping funnel was added dropwise over 3 hours. After the lapse of 2 hours at 65° C. from the completion of the dropwise addition, a solution prepared by dissolving 0.3 parts by mass of the polymerization initiator in 5 parts by mass of methyl ethyl ketone was added to the mixture, and the mixture was further aged at 65° C. for 2 hours and at 70° C. for 2 hours to produce a methyl ethyl ketone solution of addition polymer E having a carboxy group (weight average molecular weight: 20100). Thereafter, the resultant solution was dried under reduced pressure to produce an addition polymer E (acid value: 240 mgKOH/g).

### [Production of Resin Particle Dispersion]

### Production Example X1 (Production of Resin Particle Dispersion X-1)

1000 g of the resin A-1 and 1000 g of methyl ethyl ketone were added to a container having an internal volume of 5 L and equipped with a stirrer, a reflux condenser, a dropping funnel, a thermometer, and a nitrogen introduction tube, and the resin A-1 was dissolved at 80° C. over 1 hour. To the resultant solution was added 5 mass % aqueous sodium hydroxide solution so that the degree of neutralization became 80 mol % with respect to the acid value of the resin A-1, and the mixture was stirred for 30 minutes.

Subsequently, 3000 g of deionized water was added over 60 minutes with stirring at 280 r/min (peripheral velocity 88 m/min) while the temperature was maintained at 80° C., to perform phase inversion emulsification. Methyl ethyl ketone was distilled off under reduced pressure while the temperature was continuously maintained at 80° C. to produce an aqueous dispersion. Thereafter, the aqueous dispersion was cooled to 30° C. with stirring at 280 r/min (peripheral velocity 88 m/min), and then deionized water was added so that the solid content concentration became 25 mass %, to thereby produce a resin particle dispersion X-1. The volume median particle size D₅₀ and the CV value of the resin particles in the produced resin particle dispersion X-1 are shown in Table 3.

### Production Examples X2 and X3 (Production of Resin Particle Dispersions X-2 and X-3)

Resin particle dispersions X-2 and X-3 were produced in the same manner as in Production Example X1 except that the used resin A-1 was changed to resins A-2 and B-1. The volume median particle size D₅₀ and the CV value of the resin particles in the produced resin particle dispersions X-2 and X-3 are shown in Table 3.

### Production Example X4 (Production of Resin Particle Dispersion X-4)

A resin particle dispersion X-4 was produced in the same manner as in Production Example X1 except that 1000 g of the resin A-1 used was changed to 800 g of the resin A-1 and 200 g of the resin C-1. The volume median particle size D₅₀ and the CV value of the resin particles in the produced resin particle dispersion X-4 are shown in Table 3.

### Production Example P1 (Production of Resin Particle Dispersion P-1)

200 g of the resin A-1 and 200 g of methyl ethyl ketone were added to a container having an internal volume of 3 L and equipped with a stirrer, a reflux condenser, a dropping funnel, a thermometer, and a nitrogen introduction tube, and the resin A-1 was dissolved at 80° C. over 1 hour. To the resultant solution was added 5 mass % aqueous sodium hydroxide solution so that the degree of neutralization became 75 mol % with respect to the acid value of the resin A-1, and the mixture was stirred for 30 minutes. Subsequently, 700 g of deionized water was added over 50 minutes with stirring at 280 r/min (peripheral velocity 88 m/min) while the temperature was maintained at 80° C., to perform phase inversion emulsification. Methyl ethyl ketone was distilled off under reduced pressure while the temperature was continuously maintained at 80° C. to produce an aqueous dispersion. Thereafter, the aqueous dispersion was cooled to 30° C. with stirring at 280 r/min (peripheral velocity 88 m/min), and then deionized water was added so that the solid content concentration became 20 mass %, to thereby produce a resin particle dispersion P-1. The volume median particle size D₅₀ and the CV value of the resin particles in the produced resin particle dispersion P-1 are shown in Table 3.

TABLE 3

| Production Example | X1 | X2 | X3 | X4 | P1 |
|---|---|---|---|---|---|
| Resin particle dispersion | X-1 | X-2 | X-3 | X-4 | P-1 |
| Amorphous polyester resin A | A-1 (100) | A-2 (100) | B-1 (100) | A-1 (80) | A-1 (100) |
| Crystalline polyester resin C | — | — | — | C-1 (20) | — |
| Volume median particle size D₅₀ (μm) | 0.23 | 0.26 | 0.15 | 0.14 | 0.25 |
| CV value (%) | 31 | 33 | 29 | 30 | 33 |

In the table, a numerical value in parentheses means parts by mass of each resin relative to 100 parts by mass of the total amount of the resins.

### [Production of Releasing Agent Particle Dispersion]

### Production Example W1 (Production of Releasing Agent Particle Dispersion W-1)

To a beaker having an internal volume of 1 L were added 20 g of deionized water, 100 g of the resin particle dispersion P-1, and 50 g of paraffin wax “HNP-9” (available from NIPPON SEIRO CO., LTD., melting point: 75° C.), and the mixture was melted while the temperature was maintained at 90 to 95° C. and stirred to prepare a melt mixture.

The resultant melt mixture was further subjected to a dispersion treatment for 20 minutes using an ultrasonic homogenizer “US-600T” (available from NIHONSEIKI KAISHA LTD.) while the temperature was maintained at 90 to 95° C., and then the mixture was cooled to room temperature (20° C.). Deionized water was added to the mixture so that the solid content concentration was adjusted to 40 mass %, to thereby produce a releasing agent particle dispersion W-1. The volume median particle size D₅₀ of the releasing agent particles in the releasing agent particle dispersion was 0.29 μm, and the CV value was 37%.

### Production Example W2 (Production of Releasing Agent Particle Dispersion W-2)

A releasing agent particle dispersion W-2 was produced in the same manner as in Production Example W1 except that the type of the releasing agent used was changed to Fischer-Tropsch Wax “FNP-0090” (available from NIPPON SEIRO CO., LTD., melting point: 90° C.). The volume median particle size D₅₀ of the releasing agent particles in the releasing agent particle dispersion was 0.26 μm, and the CV value was 39%.

### [Production of Colorant Particle Dispersion]

### Production Example E1 (Production of Colorant Particle Dispersion E-1)

To a container having an internal volume of 2 L were added 160 g of carbon black “Printex F80” (available from Orion Engineered Carbons S.A.), 40 g of a nonionic surfactant (polyoxyethylene distyrenated phenyl ether) “EMULGEN A-60”, and 750 g of deionized water, and the mixture was stirred at 20° C. at 6400 rpm/min for 1 hour using a stirrer “LABOLUTION” (available from PRIMIX Corporation) equipped with a dispersion blade. Thereafter, the mixture was caused to pass through a 200-mesh filter and subjected to 15 pass treatment at a pressure of 150 MPa using a homogenizer “Microfluidizer M-110 EH” (available from Microfluidics Corporation). Thereafter, the mixture was caused to pass through a 200-mesh filter, and deionized water was added thereto so that the solid content concentration became 20 mass %, to thereby produce a colorant particle dispersion E-1. The volume median particle size D₅₀ and the CV value of the colorant particles in the produced colorant particle dispersion E-1 are shown in Table 4.

### Production Examples E2 to E4, E6, and E7 (Production of Colorant Particle Dispersions E-2 to E-4, E-6, and E-7)

Colorant particle dispersions were produced in the same manner as in Production Example E1 except that the colorant to be used was changed. The volume median particle size D₅₀ and CV value of the colorant particles in the produced colorant particle dispersions E-2 to E-4, E-6, and E-7 are shown in Table 4.

### Production Example E5 (Production of Colorant Particle Dispersion E-5)

To a container having an internal volume of 2 L were added 40 g of the addition polymer E and 218 g of methyl ethyl ketone, and the addition polymer E was dissolved at 20° C. To the resultant solution was added 32 g of 5 mol/L aqueous sodium hydroxide solution (solid content concentration: 16.9 mass %) (amount such that the degree of neutralization was 80 mol % with respect to the acid value of the addition polymer E), and 516 g of deionized water was further added, and the mixture was stirred at 20° C. for 10 minutes at 2000 r/min with a dispersion blade. Subsequently, 160 g of carbon black Printex F80 (carbon black, available from Orion Engineered Carbons S.A.) was added, and the mixture was stirred with a dispersion blade at 6400 r/min at 10° C. for 1 hour. Thereafter, the mixture was caused to pass through a 200-mesh filter and subjected to 5 pass treatment at a pressure of 150 MPa using a homogenizer “Microfluidizer M-110 EH” (available from Microfluidics Corporation). While the resultant dispersion was stirred, methyl ethyl ketone and a portion of water were removed at 70° C. under reduced pressure. After cooling, the mixture was caused to pass through a 200-mesh filter, and deionized water was added thereto so that the solid content concentration became 20 mass %, to thereby produce a colorant particle dispersion E-5. The volume median particle size D₅₀ and the CV value of the colorant particles in the produced colorant particle dispersion E-5 are shown in Table 4.

TABLE 4

| | Production Example | | | | | | |
|---|---|---|---|---|---|---|---|
| | E1 | E2 | E3 | E4 | E5 | E6 | E7 |
| Colorant particle dispersion | E-1 | E-2 | E-3 | E-4 | E-5 | E-6 | E-7 |
| Type of pigment | CB1 | CB2 | CB3 | CB4 | CB1 | CB5 | CB6 |
| BET specific surface area (m²/g) | 225 | 240 | 258 | 258 | 225 | 116 | 95 |
| Colorant (pigment) dispersant | EMULGEN | EMULGEN | EMULGEN | EMULGEN | Addition | EMULGEN | EMULGEN |
| | A-60 | A-60 | A-60 | A-60 | polymer E | A-60 | A-60 |
| Colorant/colorant dispersant (mass | 80/20 | 80/20 | 80/20 | 80/20 | 80/20 | 80/20 | 80/20 |
| ratio) | | | | | | | |
| Volume median particle size D₅₀ (μm) | 0.08 | 0.09 | 0.09 | 0.09 | 0.08 | 0.11 | 0.12 |
| CV value (%) | 23 | 24 | 26 | 25 | 23 | 24 | 25 |

CB1: Carbon black “Printex F80” (available from Orion Engineered Carbons S.A.)
CB2: Carbon black “Black Pearls 4750” (available from Cabot Corporation)
CB3: Carbon black “Monarch 4750” (available from Cabot Corporation)
CB4: Carbon black “Monarch 880” (available from Cabot Corporation)
CB5: Carbon black “Black Pearls 4350” (available from Cabot Corporation)
CB6: Carbon black “Regal 330” (available from Cabot Corporation)

### [Production of Toner]

### Example 1 (Production of Toner 1)

500 g of the resin particle dispersion X-1, 35 g of the releasing agent particle dispersion W-1, 35 g of the releasing agent particle dispersion W-2, and 63 g of the colorant particle dispersion E-1 were placed in a 3 L four-necked flask equipped with a dehydration tube, a stirrer, and a thermocouple, and the dispersions were mixed at a temperature of 25° C. Subsequently, while the mixture was stirred, a solution prepared by adding 4.8 mass % aqueous potassium hydroxide solution to an aqueous solution of 46 g of ammonium sulfate in 1346 g of deionized water to adjust the pH to 8.0 was added dropwise to the mixture at 25° C. over 30 minutes. Thereafter, the temperature was increased to 55° C. over 1 hour, and the temperature was held at 55° C. until the volume median particle size D₅₀ of the aggregated particles became 6.0 μm, to thereby produce a dispersion of the aggregated particles 1.

To the produced dispersion of the aggregated particles 1 were added 155 g of 20 mass % aqueous solution of DEMOL N (sodium salt of β-naphthalenesulfonic acid formalin condensate, available from Kao Corporation), 1690 g of deionized water, and 253 g of 4.8 mass % aqueous potassium hydroxide solution. Thereafter, the temperature was increased to 70° C. over 1 hour and held at 70° C. until the circularity reached 0.970, to thereby produce a dispersion of coalesced particles formed by coalescing of the aggregated particles 1.

The produced dispersion of coalesced particles was cooled to 30° C., and the dispersion was subjected to suction filtration to separate a solid content. Thereafter, the resultant produce was washed with deionized water at 25° C., and subjected to suction filtration at 25° C. for 2 hours. Thereafter, vacuum drying was performed at 33° C. for 24 hours using a vacuum constant temperature dryer “DRV 622DA” (available from ADVANTEC) to produce toner particles. 100 parts by mass of the toner particles, 2.5 parts by mass of hydrophobic silica “RY50” (available from Nippon Aerosil Co., Ltd., number average particle size; 0.04 μm), and 1.0 part by mass of hydrophobic silica “CAB-O-SIL (registered trademark) TS720” (available from Cabot Japan Co., Ltd., number average particle size; 0.012 μm) were placed in a Henschel mixer and stirred, and the mixture was caused to pass through a 150-mesh sieve to produce a toner 1. The produced toner 1 was evaluated as follows. The physical property values of the toner particles and the evaluation results of the toner 1 are shown in Table 5.

### [Evaluation of Toner]

### [Image Density of Printed Matter]

By using a commercially available printer “Microline (registered trademark) 5400” (available from OKI Electric Industry Co., Ltd.), a solid image in which the toner adhesion amount on paper was 0.35 mg/cm² was output on a high quality paper “J paper A4 size” (available from FUJIFILM Business Innovation Corp.) without being fused.

Subsequently, the same printer in which the fusing device was modified to be variable in temperature was provided, the temperature of the fusing device was set to 130° C., and the toner was fused at a rate of 1.5 seconds per sheet in the A4 longitudinal direction to form a printed matter.

Thirty sheets of high-quality paper “Excellent white paper A4 size” (available from OKI Electric Industry Co., Ltd.) were placed under the printed matter, the reflection image density of the solid image portion of the output printed matter was measured using a colorimeter “SpectroEye” (available from GretagMacbeth LLC, photoradiation conditions; standard light source D50, observation field of view 2°, concentration reference DINNB, absolute white reference), and the values obtained by measurement at any 10 points on the image were averaged to determine the image density. The larger the numerical value, the more excellent the image density.

### Examples 2 to 7 and Comparative Examples 1 to 3 (Production of Toners 2 to 7 and 51 to 53)

Toner particles 2 to 7 and 51 to 53 and toners 2 to 7 and 51 to 53 were produced in the same manner as in Example 1 except that the type of the resin particle dispersion used and the type of the colorant particle dispersion used were changed as shown in Table 5. The physical property values of the produced toner particles and the evaluation results of the toner are shown in Table 5.

TABLE 5

| | | Example 1 | Example 2 | Example 3 | Example 4 | Examples 5 |
|---|---|---|---|---|---|---|
| Toner | | 1 | 2 | 3 | 4 | 5 |
| Production method | | Emulsion | Emulsion | Emulsion | Emulsion | Emulsion |
| | | aggregation | aggregation | aggregation | aggregation | aggregation |
| Resin particle dispersion | | X-1 | X-1 | X-1 | X-1 | X-1 |
| Resin | Amorphous | A-1 | A-1 | A-1 | A-1 | A-1 |
| | polyester resin A | | | | | |
| | Crystalline | — | — | — | — | — |
| | polyester resin C | | | | | |
| | Ester group | 8.2 | 8.2 | 8.2 | 8.2 | 8.2 |
| | concentration | | | | | |
| | (mmol/g)*¹ | | | | | |
| | Ester group | — | — | — | — | — |
| | concentration | | | | | |
| | (mmol/g)*² | | | | | |
| Colorant | Colorant | E-1 | E-2 | E-3 | E-4 | E-5 |
| particles | (pigment) particle | | | | | |
| | dispersion | | | | | |
| | Type of pigment | CB1 | CB2 | CB3 | CB4 | CB1 |
| | BET specific | 225 | 240 | 258 | 258 | 225 |
| | surface area | | | | | |
| | (m²/g) | | | | | |
| | Type of pigment | EMULGEN | EMULGEN | EMULGEN | EMULGEN | Addition |
| | dispersant | A-60 | A-60 | A-60 | A-60 | polymer E |
| | Colorant/pigment | 80/20 | 80/20 | 80/20 | 80/20 | 80/20 |
| | dispersant (mass | | | | | |
| | ratio) | | | | | |
| Releasing agent particle | | W-1 | W-1 | W-1 | W-1 | W-1 |
| dispersion | | W-2 | W-2 | W-2 | W-2 | W-2 |
| Physical | Volume median | 6.0 | 6.3 | 6.3 | 6.2 | 6.2 |
| properties | particle size D₅₀ | | | | | |
| of toner | (μm) | | | | | |
| particles | CV value (%) | 27 | 30 | 33 | 34 | 25 |
| Evaluation | Image density of | 1.64 | 1.62 | 1.61 | 1.58 | 1.74 |
| of toner | printed matter | | | | | |
| | Toner adhesion | | | | | |
| | amount 0.35 | | | | | |
| | mg/cm² | | | | | |
| | | | | Comparative | Comparative | Comparative |
| | | Example 6 | Example 7 | Example 1 | Example 2 | Example 3 |
| Toner | | 6 | 7 | 51 | 52 | 53 |
| Production method | | Emulsion | Emulsion | Emulsion | Emulsion | Emulsion |
| | | aggregation | aggregation | aggregation | aggregation | aggregation |
| Resin particle dispersion | | X-2 | X-4 | X-3 | X-1 | X-1 |
| Resin | Amorphous | A-2 | A-1 | B-1 | A-1 | A-1 |
| | polyester resin A | | | | | |
| | Crystalline | — | C-1 | — | — | — |
| | polyester resin C | | | | | |
| | Ester group | 10.3 | 8.2 | 4.3 | 8.2 | 8.2 |
| | concentration | | | | | |
| | (mmol/g)*¹ | | | | | |
| | Ester group | — | 7.5 | — | — | — |
| | concentration | | | | | |
| | (mmol/g)*² | | | | | |
| Colorant | Colorant | E-1 | E-1 | E-1 | E-6 | E-7 |
| particles | (pigment) particle | | | | | |
| | dispersion | | | | | |
| | Type of pigment | CB1 | CB1 | CB1 | CB5 | CB6 |
| | BET specific | 225 | 225 | 225 | 116 | 95 |
| | surface area | | | | | |
| | (m²/g) | | | | | |
| | Type of pigment | EMULGEN | EMULGEN | EMULGEN | EMULGEN | EMULGEN |
| | dispersant | A-60 | A-60 | A-60 | A-60 | A-60 |
| | Colorant/pigment | 80/20 | 80/20 | 80/20 | 80/20 | 80/20 |
| | dispersant (mass | | | | | |
| | ratio) | | | | | |
| Releasing agent particle | | W-1 | W-1 | W-1 | W-1 | W-1 |
| dispersion | | W-2 | W-2 | W-2 | W-2 | W-2 |
| Physical | Volume median | 6.2 | 6.1 | 6.2 | 6.2 | 6.2 |
| properties | particle size D₅₀ | | | | | |
| of toner | (μm) | | | | | |
| particles | CV value (%) | 34 | 30 | 31 | 30 | 30 |
| Evaluation | Image density of | 1.58 | 1.75 | 1.40 | 1.43 | 1.37 |
| of toner | printed matter | | | | | |
| | Toner adhesion | | | | | |
| | amount 0.35 | | | | | |
| | mg/cm² | | | | | |

*¹Ester group concentration of resin A
*²Ester group concentration of resin C
CB1: Carbon black “Printex F80” (available from Orion Engineered Carbons S.A.)
CB2: Carbon black “Black Pearls 4750” (available from Cabot Corporation)
CB3: Carbon black “Monarch 4750” (available from Cabot Corporation)
CB4: Carbon black “Monarch 880” (available from Cabot Corporation)
CB5: Carbon black “Black Pearls 4350” (available from Cabot Corporation)
CB6: Carbon black “Regal 330” (available from Cabot Corporation)

### Example 8 (Production of Toner 8)

100 parts by mass of the resin A-1, 8 parts by mass of carbon black (Printex F80 available from Cabot Corporation), 3 parts by mass of Fischer-Tropsch Wax “FNP-0090” (available from NIPPON SEIRO CO., LTD., melting point: 90° C.) as a releasing agent, and 3 parts by mass of “HNP-9” (paraffin wax available from NIPPON SEIRO CO., LTD., melting point: 78° C.) were stirred and mixed with a Henschel mixer for 2 minutes, and then melt-kneaded under the following conditions.

A continuous twin open-roll type kneader “Kneadex” (available from NIPPON COKE & ENGINEERING CO., LTD., roll outer diameter: 14 cm, effective roll length: 80 cm) was used. The operating conditions of the continuous twin open-roll type kneader were a high rotation side roll (front roll) rotation speed of 75 r/min (peripheral velocity 33 m/min), a low rotation side roll (back roll) rotation speed of 50 r/min (peripheral velocity 22 m/min), and a roll gap of 0.1 mm at the end on the kneaded product supply port side. The temperature of the heating medium and the temperature of the cooling medium in the roll were as follows: 145° C. at the end on the raw material charging side and 110° C. at the end on the kneaded product discharging side of the high rotation side roll, and 35° C. at the end on the raw material charging side and 35° C. at the end on the kneaded product discharging side of the low rotation side roll. The feed rate of the raw material mixture was 10 kg/h, and the average residence time was about 6 minutes.

The resultant melt-kneaded product was cooled to 20° C. or lower while being rolled with a cooling roll, and the cooled melt-kneaded product was coarsely pulverized to 3 mm with Rotoplex (available from TOA KIKAI SEISAKUSYO), and then pulverized and classified so that the volume median particle size (D₅₀) became 7.0 μm using an IDS pulverizer/classifier (available from Nippon Pneumatic Mfg. Co., Ltd.) which is an air flow type jet mill, to produce toner particles 8.

100 parts by mass of the toner particles 8, 2.5 parts by mass of hydrophobic silica “RY50” (available from Nippon Aerosil Co., Ltd., number average particle size; 0.04 μm), and 1.0 part by mass of hydrophobic silica “CAB-O-SIL (registered trademark) TS720” (available from Cabot Japan Co., Ltd., number average particle size; 0.012 μm) were placed in a Henschel mixer and stirred, and the mixture was caused to pass through a 150-mesh sieve to produce a toner 8. The physical property values of the produced toner particles 8 and the evaluation results of the toner 8 are shown in Table 6.

TABLE 6

| | | Example 8 |
|---|---|---|
| Toner | | 8 |
| Production method | | Pulverization method |
| Resin | Amorphous polyester resin A | A-1 |
| | Ester group concentration (mmol/g) | 8.2 |
| Colorant | Type of pigment | CB1 |
| | BET specific surface area (m²/g) | 225 |
| Releasing agent | | FNP-0090 |
| | | HNP-9 |
| Physical properties of toner particles | Volume median particle size D₅₀ (μm) | 6.1 |
| | CV value (%) | 28 |
| Evaluation of toner | Image density of printed matter | 1.56 |
| | Toner adhesion amount 0.35 mg/cm² | |

CB1: Carbon black “Printex F80” (available from Orion Engineered Carbons S.A.)
FNP-0090: Fischer-Tropsch Wax (available from NIPPON SEIRO CO., LTD., melting point: 90° C.)
HNP-9: Paraffin wax (available from NIPPON SEIRO CO., LTD., melting point: 78° C.)

As shown in Tables 5 and 6, the printed matter produced using the toner of the present invention containing the amorphous polyester resin A having an ester group concentration of 5.0 mmol/g or more and 15.0 mmol/g or less and carbon black having a BET specific surface area of 200 m²/g or more exhibits excellent image density (Examples 1 to 8).

In contrast, the printed matter produced using the toner containing carbon black having a BET specific surface area of 200 m²/g or more and the amorphous polyester-based resin B-1 having an ester group concentration (4.5 mmol/g) falling outside the range specified by the present invention exhibited poor image density (Comparative Example 1). Meanwhile, the printed matter produced using the toner containing the amorphous polyester resin A having an ester group concentration of 5.0 mmol/g or more and 15.0 mmol/g or less and carbon black having a BET specific surface area (116 m²/g, 95 m²/g) falling outside the range specified by the present invention exhibited poor image density (Comparative Examples 2 and 3).

1. A toner for electrostatic image development, comprising:
a binder resin; and
a colorant,
wherein the binder resin comprises an amorphous polyester resin A having an ester group concentration of from 5.0 mmol/g to 15.0 mmol/g,
the amorphous polyester resin A has an acid value of from 5 mgKOH/g to 30 mgKOH/g, and
the colorant comprises carbon black has a BET specific surface area of 200 m²/g or more.

2. The toner for electrostatic image development according to claim 1, wherein the amorphous polyester resin A comprises a polycondensate of an alcohol component (a) and a carboxylic acid component (b), and
the alcohol component (a) comprises a linear or branched aliphatic diol having from 2 to 6 carbons.

3. The toner for electrostatic image development according to claim 2, wherein a content of the aliphatic diol in the alcohol component (a) is 80 mol % or more.

4. The toner for electrostatic image development according to claim 1, wherein the binder resin further comprises a crystalline polyester resin C.

5. The toner for electrostatic image development according to claim 4, wherein the crystalline polyester resin C has an ester group concentration of from 5.0 mmol/g to 12.0 mmol/g.

6. The toner for electrostatic image development according to claim 4, wherein a mass ratio of the crystalline polyester resin C to the amorphous polyester resin A [crystalline polyester resin C/amorphous polyester resin A] is from 5/95 to 40/60.

7. The toner for electrostatic image development according to claim 1, wherein the carbon black has a BET specific surface area of from 200 m²/g to 290 m²/g.

8. The toner for electrostatic image development according to claim 1, wherein the carbon black has a BET specific surface area of from 210 m²/g to 250 m²/g.

9. The toner for electrostatic image development according to claim 1, wherein the toner for electrostatic image development comprises toner particles, and a content of carbon black in the toner particles is from 2 mass % to 20 mass %.

10. A method for producing the toner of claim 1, the method comprising:
aggregating and coalescing resin particles and colorant particles,
wherein the resin particles comprise an amorphous polyester resin A having an ester group concentration of from 5.0 mmol/g to 15.0 mmol/g, and
the colorant particles comprise carbon black having a BET specific surface area of 200 m²/g or more.

11. The method of claim 10, wherein a heating temperature in the coalescing is 100° C. or lower.

12. The method of claim 10, further comprising:
preparing a colorant particle dispersion comprising carbon black having a BET specific surface area of 200 m²/g or more by using an addition polymer E that is a pigment dispersant.

13. The toner for electrostatic image development according to claim 1, wherein the amorphous polyester resin A is a polycondensate of an alcohol component (a) and a carboxylic acid component (b),
the carboxylic acid component (b) comprises an aromatic dicarboxylic acid, and
a content of the aromatic dicarboxylic acid in the carboxylic acid component (b) is 70 mol % or more.

14. The toner for electrostatic image development according to claim 4, wherein a weighted average of the ester group concentrations of the amorphous polyester resin A and the crystalline polyester resin C is from 5.0 mmol/g to 13.0 mmol/g.

15. The toner for electrostatic image development according to claim 1, wherein the carbon black comprises at least one selected from the group consisting of furnace black, thermal lamp black, acetylene black, and channel black.

16. The toner for electrostatic image development according to claim 1, wherein the carbon black has a pH value of from 5.0 to 10.0.

17. The toner for electrostatic image development according to claim 1, wherein the carbon black has a dibutyl phthalate oil absorption of from 30 mL/100 g to 160 mL/100 g.
